(19) United States
(12) Patent Application Publication
(10) Pub. No.: US 2023/0044648 A1
(43) Pub. Date: Feb. 9, 2023

(54) Method for Capacity Indication in Extended UE Configuration

(71) Applicant: Telefonaktiebolaget LM Ericsson (publ), Stockholm (SE)

(72) Inventors: Angelo Centonza, Torrenueva Costa, Granada (ES); Pradeepa Ramachandra, Linköping (SE); Oumer Teyeb, Montréal (CA)

(21) Appl. No.: 17/787,869

(22) PCT Filed: Jan. 14, 2021
(86) PCT No.: PCT/SE2021/050018

§ 371 Date: Jun. 21, 2022

Related U.S. Application Data
(60) Provisional application No. 62/965,343, filed on Jan. 24, 2020.

(51) Int. Cl. H04W 36/22; H04W 28/08; H04W 36/00

(52) U.S. Cl. CPC H04W 36/22; H04W 28/0808; H04W 36/0058; H04W 92/20

(57) ABSTRACT

Embodiments include methods, by a first radio access network (RAN) node, for load balancing with a second RAN node. Such methods include receiving, from the second RAN node, one or more first indications related to resource aggregation capabilities for a plurality of cells served by the second RAN node. Such methods include determining one or more of the following based on the first indications: overall capacity available for offloading user equipment, UEs, to the plurality of cells; whether resources from the plurality of cells can be aggregated to meet service requirements of one or more UEs served by the first RAN node; and one or more UEs to be handed over to the second RAN node. Other embodiments include complementary methods by a second RAN node, as well as first and second RAN nodes configured to perform such methods.

### TECHNICAL FIELD

The present application relates generally to the field of wireless communications, and more specifically to devices, methods, and computer-readable media that facilitate, enable, and/or improve load balancing between nodes in a radio access network (RAN).

### BACKGROUND

Currently the fifth generation (“5G”) of cellular systems, also referred to as New Radio (NR), is being standardized within the Third-Generation Partnership Project (3GPP). 5G/NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. The present disclosure relates generally to NR, but the following description of Long Term Evolution (LTE) technology is provided for context since it shares many features with NR.

LTE is an umbrella term for fourth generation (4G) radio access technologies (RATs) developed within 3GPP and initially standardized in Releases 8 and 9, also known as Evolved UTRAN (E-UTRAN). LTE is available in various frequency bands and is accompanied by improvements to non-radio aspects referred to as System Architecture Evolution (SAE), including the Evolved Packet Core (EPC) network. LTE continues to evolve through subsequent releases.

An overall exemplary architecture of a network comprising LTE and SAE is shown in FIG. 1. E-UTRAN 100 includes one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) that is capable of communicating with 3GPP-standard-compliant network equipment, including E-UTRAN as well as UTRAN and/or GERAN, as the third-generation (“3G”) and second-generation (“2G”) 3GPP RANs are commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. Each of the eNBs can serve a geographic coverage area including one more cells, including cells 106, 111, and 115 served by eNBs 105, 110, and 115, respectively.

The eNBs in the E-UTRAN communicate with each other via the X2 interface, as shown in FIG. 1. The eNBs also are responsible for the E-UTRAN interface to the EPC 130, specifically the Si interface to the Mobility Management Entity (MME) and the Serving Gateway (SGW), shown collectively as MME/S-GWs 134 and 138 in FIG. 1. In general, the MME/S-GW handles both the overall control of the UE and data flow between the UE and the rest of the EPC. More specifically, the MME processes the signaling (e.g., control plane) protocols between the UE and the EPC, which are known as the Non-Access Stratum (NAS) protocols. The S-GW handles all Internet Protocol (IP) data packets (e.g., data or user plane) between the UE and the EPC and serves as the local mobility anchor for the data bearers when the UE moves between eNBs, such as eNBs 105, 110, and 115.

EPC 130 can also include a Home Subscriber Server (HSS) 131, which manages user- and subscriber-related information. HSS 131 can also provide support functions in mobility management, call and session setup, user authentication and access authorization. The functions of HSS 131 can be related to the functions of legacy Home Location Register (HLR) and Authentication Centre (AuC) functions or operations. HSS 131 can also communicate with MMES 134 and 138 via respective Sha interfaces.

In some embodiments, HSS 131 can communicate with a user data repository (UDR)-labelled EPC-UDR 135 in FIG. 1—via a Ud interface. EPC-UDR 135 can store user credentials after they have been encrypted by AuC algorithms. These algorithms are not standardized (i.e., vendor-specific), such that encrypted credentials stored in EPC-UDR 135 are inaccessible by any other vendor than the vendor of HSS 131.

FIG. 2 illustrates a block diagram of an exemplary control plane (CP) protocol stack between a UE, an eNB, and an MME. The exemplary protocol stack includes Physical (PHY), Medium Access Control (MAC), Radio Link Control (RLC), Packet Data Convergence Protocol (PDCP), and Radio Resource Control (RRC) layers between the UE and eNB. The PHY layer provides resources for transferring data over transport channels via the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PDCP layer provides ciphering/deciphering and integrity protection for both CP and user plane (UP), as well as other UP functions such as header compression. The exemplary protocol stack also includes non-access stratum (NAS) signaling between the UE and the MME.

The RRC layer controls communications between a UE and an eNB at the radio interface, as well as the mobility of a UE between cells in the E-UTRAN. After a UE i s powered ON it will be in the RRC_IDLE state until an RRC connection is established with the network. at which time the UE will transition to RRC_CONNECTED state (e.g., where data transfer can occur). The LE returns to RRC_IDLE after the connection with the network is released. In RRC_IDLE state, the UE does not belong to any cell, no RRC context has been established for the UE (e.g., in E-UTRAN), and the UE is out of UL synchronization with the network. Even so, a UE in RRC-IDLE state is known in the EPC and has an assigned IP address.

Furthermore, in RRC_IDLE state, the UE's radio is active on a discontinuous reception (DRX) schedule configured by upper layers. During DRX active periods (also referred to as “DRX On durations”), an RRC_IDLE UE receives system information (SI) broadcast by a serving cell, performs measurements of neighbor cells to support cell reselection, and monitors a paging channel for pages from the EPC via an eNB serving the cell in which the UE is camping.

A UE must perform a random-access (RA) procedure to move from RRC_IDLE to RRC_CONNECTED state. In RRC_CONNECTED state, the cell serving the UE is known and an RRC context is established for the UE in the serving eNB, such that the UE and eNB can communicate. For example, a Cell Radio Network Temporary Identifier (C-RNTI)—a UE identity used for signaling between UE and network—is configured for a UE in RRC_CONNECTED state.

LTE Rel-10 added support for bandwidths larger than 20 MHz, while remaining backward compatible with Rel-8. As such, a wideband carrier (e.g., wider than 20 MHz) should appear as a number of carriers (referred to as “component carriers” or “CCs”) to an LTE Rel-8 terminal. For an efficient use of a wideband carrier, legacy (e.g., Rel-8) terminals can be scheduled in all parts of the wideband carrier. One way to achieve this is by Carrier Aggregation (CA), whereby a compatible UE can receive multiple CCs, each preferably having the same structure as a Rel-8 carrier. In the context of CA, the terms “carrier,” “component carrier,” (or CC) and “cell” (or “serving cell”) are often used interchangeably.

The UE's RRC connection is handled by one serving cell (primary serving cell, PCell) associated with the primary component carrier (DL and UL PCC). The UE also receives NAS information on the DL PCC, such as security parameters. In RRC_IDLE state, the UE listens to system information (SI) broadcast on the DL PCC and transmits physical uplink control channel (PUCCH) on UL PCC. The other CCs are known as secondary component carriers (DL and UL SCC), each associated with a secondary serving cell (SCell). A UE's SCCs/SCells are added and removed as required, while the UE's PCC/PCell is only changed during mobility procedures (e.g., handover).

To support mobility between cells and/or beams, a UE can perform periodic cell search and measurements of signal power (e.g., reference signal received power, RSRP), signal quality (e.g., reference signal received quality, RSRQ), and/or signal-to-interference-plus-noise ratio (SINR) in both RRC_CONNECTED and RRC_IDLE states. A UE is responsible for detecting new neighbor cells, and for tracking and monitoring already detected cells. An LTE UE can perform such measurements on various downlink reference signals (RS) including, e.g., cell-specific Reference Signal (CRS), MBSFN reference signals, UE-specific demodulation reference signals (DM-RS) associated with PDSCH, DM-RS associated with (e/M/N)PDCCH, Positioning Reference Signal (PRS), and CSI Reference Signal (CSI-RS).

Detected cells and measurement values associated with monitored and/or detected cells are reported to the network. Reports can be configured to be periodic or aperiodic based a particular event. Such reports are commonly referred to as mobility measurement reports and contain channel state information (CSI). These reports can be used, e.g., to make mobility and resource management decisions such as UE handover and/or dynamic activation or deactivation of SCells in a UE's CA configuration.

LTE networks include a load balancing (LB) function that handles uneven distribution of the traffic load over multiple cells. In general, LB attempts to distribute the network load (e.g., UEs and data traffic) so that network radio resources are highly utilized, the quality of service (QoS) of in-progress user data sessions are maintained to the extent possible, and call dropping probabilities are kept sufficiently small. As such, LB algorithms may generate and/or initiate handover or cell reselection of various UEs and/or traffic from highly loaded cells to underutilized cells. Load balancing is also expected to be an important feature for 5G/NR networks.

In general, load balancing is based on RAN interface procedures (i.e., between RAN nodes) to exchange load and/or capacity information related to RAN nodes and cells. Information such as resource utilization and available capacity can be provided and/or indicated on a per cell basis (for LTE or NR) or per beam area basis within a cell (for NR). However, such information does not adequately represent the capacity available at neighbor RAN nodes when UEs are configured for CA with multiple carriers. This can cause RAN nodes to make incorrect load balancing decisions, thereby frustrating the load balancing goals discussed above.

### SUMMARY

Accordingly, exemplary embodiments of the present disclosure address these and other mobility-related issues in wireless communication networks by providing improvements to load balancing operations between RAN nodes based on information related to resource aggregation capabilities in a target RAN node.

Embodiments of the present disclosure include methods (e.g., procedures) for load balancing between a first RAN node and a second RAN node. These exemplary methods can be performed by the first RAN node (e.g., base station, eNB, gNB, ng-eNB, etc., or component thereof).

These exemplary methods can include receiving, from the second RAN node, one or more first indications related to resource aggregation capabilities for a plurality of cells served by the second RAN node. In some embodiments, the resource aggregation capabilities can include carrier aggregation (CA) and/or dual connectivity (DC). In various embodiments, the first indications can include one or more of the following indications:
that resources from the plurality of cells can be aggregated to serve a UE that is handed over to the second RAN node;
an estimated likelihood that resources from the plurality of cells can be aggregated to serve a UE that is handed over to the second RAN node;
that the plurality of cells overlap in coverage;
a degree of overlap in coverage between the plurality of cells; and
whether the plurality of cells are served by the same distributed unit (DU) or different DUs associated with the second RAN node.

In some embodiments, the first indications can be received in a single message. For example, the first and second RAN nodes can be gNBs in an NG-RAN. In such embodiments, the first indications can be received in a Resource Status Update message over an Xn interface between the first and second RAN nodes. In other embodiments, a first portion of the first indications can be received during setup of an interface between the first and second RAN nodes, and a second portion of the first indications can be received after the interface is setup.

In some embodiments, these exemplary methods can also include receiving, from the second RAN node, one or more second indications related to traffic load or available capacity for individual cells of the plurality. The one or more second indications can be received in a separate message or in the same message as the first indications.

In some embodiments, the exemplary method can also include receiving, from one or more UEs served by the first RAN node, measurements relating to the plurality of cells served by the second RAN node.

These exemplary methods can also include determining one or more of the following based on the first indications: overall capacity available for offloading UEs to the plurality of cells; whether resources from the plurality of cells can be aggregated to meet service requirements of one or more UEs served by the first RAN node; and one more UEs to be handed over the second RAN node. In some embodiments, the determining operations can be based on other information, such as the second indications and/or the UE measurements previously received.

In some embodiments, the determining operations can include selecting the one or more UEs to be handed over based on UE support for the resource aggregation capabilities indicated by the first indications.

In some embodiments, these exemplary methods can also include, in response to the determining operation, sending to the second RAN node one or more requests for handover of respective one or more UEs to the plurality of cells. These handover requests can be for load balancing, as facilitated by the first indications (and optionally information) received earlier.

Other embodiments include additional methods (e.g., procedures) for load balancing between a first RAN node and a second RAN node. These exemplary methods can be performed by the second RAN node (e.g., base station, eNB, gNB, ng-eNB, etc., or component thereof).

These exemplary methods can include sending, to the first RAN node, one or more first indications related to resource aggregation capabilities for a plurality of cells served by the second RAN node. In some embodiments, the resource aggregation capabilities can include carrier aggregation (CA) and/or dual connectivity (DC). In various embodiments, the first indications can include one or more of the following indications:
that resources from the plurality of cells can be aggregated to serve a UE that is handed over to the second RAN node;
an estimated likelihood that resources from the plurality of cells can be aggregated to serve a UE that is handed over to the second RAN node;
that the plurality of cells overlap in coverage;
a degree of overlap in coverage between the plurality of cells; and
whether the plurality of cells are served by the same distributed unit (DU) or different DUs associated with the second RAN node.

In some embodiments, the first indications are sent in a single message. For example, the first and second RAN nodes can be gNBs in an NG-RAN. In such embodiments, the first indications can be sent in a Resource Status Update message over an Xn interface between the first and second RAN nodes. In other embodiments, a first portion of the first indications can be sent during setup of an interface between the first and second RAN nodes, and a second portion of the first indications can be sent after the interface is setup.

In some embodiments, these exemplary methods can also include sending, to the first RAN node, one or more second indications related to traffic load or available capacity for individual cells of the plurality. The one or more second indications can be sent in a separate message or in the same message as the first indications.

These exemplary methods can also include receiving, from the first RAN node, one or more requests for handover of respective one or more UEs to the plurality of cells associated with the one or more first indications. These handover requests can be for load balancing, as facilitated by the first indications (and optionally information) sent earlier. In some embodiments, these exemplary methods can also include, after handover of the one or more UEs, communicating with at least one of the UEs using aggregated resources from the plurality of cells associated with the one or more first indication.

Other embodiments include RAN nodes (e.g., base stations, eNBs, gNBs, ng-eNBs, etc. or components thereof) configured to perform operations corresponding to any of the exemplary methods described herein. Other exemplary embodiments include non-transitory, computer-readable media storing computer-executable instructions that, when executed by processing circuitry, configure a RAN node to perform operations corresponding to any of the exemplary methods described herein.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 is a high-level block diagram of an exemplary architecture of the Long-Term Evolution (LTE) Evolved UTRAN (E-UTRAN) and Evolved Packet Core (EPC) network, as standardized by 3GPP.

FIG. 2 is a block diagram of exemplary protocol layers of the control-plane portion of the radio (Uu) interface between a user equipment (UE) and the E-UTRAN.

FIGS. 3-4 show two high-level views of an exemplary 5G network architecture.

FIG. 5 illustrates an exemplary LTE mobility load balancing (MLB) scenario involving three eNBs.

FIG. 6, which includes FIGS. 6A-6C, shows signaling flows related to Resource Status Reporting procedures between NG-RAN nodes in a 5G network.

FIG. 7 shows an exemplary scenario that illustrates certain load-balancing issues, difficulties, and/or problems related to carrier aggregation (CA).

FIG. 8 shows an exemplary load-balancing scenario that illustrates various embodiments of the present disclosure.

FIG. 9 illustrates an exemplary method (e.g., procedure) for a second radio access network (RAN) node, according to various exemplary embodiments of the present disclosure.

FIG. 10 illustrates an exemplary method (e.g., procedure) for a first RAN node, according to various exemplary embodiments of the present disclosure.

FIG. 11 illustrates an exemplary embodiment of a wireless network, in accordance with various aspects described herein.

FIG. 12 illustrates an exemplary embodiment of a UE, in accordance with various aspects described herein.

FIG. 13 is a block diagram illustrating an exemplary virtualization environment usable for implementation of various embodiments of network nodes described herein.

FIGS. 14-15 are block diagrams of various exemplary communication systems and/or networks, according to various exemplary embodiments of the present disclosure.

FIGS. 16-19 are flow diagrams of exemplary methods (e.g., procedures) for transmission and/or reception of user data, according to various exemplary embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the disclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a transmission reception point (TRP), a remote radio unit (RRU or RRH), a relay node, or a non-terrestrial access node (e.g., satellite or gateway). For example, a multi-TRP arrangement may include more than one TRP associated with one or more radio access nodes.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP-specific terminology (or equivalent) is oftentimes used. However, the concepts disclosed herein are not limited to a 3GPP system and can be applied to any wireless system having appropriate and/or relevant functionality. Furthermore, although the term “cell” is used herein, it should be understood that (particularly with respect to 5G NR) beams may be used instead of cells and, as such, concepts described herein apply equally to both cells and beams.

As discussed above, load balancing (LB) uses RAN interface procedures (i.e., between RAN nodes) to exchange load and/or capacity information related to RAN nodes and cells. Information such as resource utilization and available capacity can be provided and/or indicated on a per cell basis (for LTE or NR) or per beam area basis within a cell (for NR). However, such information does not adequately represent the capacity available at neighbor RAN nodes when UEs are configured for CA with multiple carriers. This can cause RAN nodes to make incorrect load balancing decisions, thereby frustrating the load balancing goals discussed above. These aspects are discussed in more detail below, along with exemplary solutions provided by embodiments of the present disclosure.

5G/NR technology shares many similarities with fourth-generation LTE. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. As another example, NR RRC layer includes RRC_IDLE and RRC_CONNECTED states, but adds an additional state known as RCC_INACTIVE, which has some properties similar to a “suspended” condition used in LTE.

In addition to providing coverage via “cells,” as in LTE, NR networks also provide coverage via “beams.” In general, a DL “beam” is a coverage area of a network-transmitted RS that may be measured or monitored by a UE. In NR, for example, such RS can include any of the following, alone or in combination: synchronization signal/PBCH block (SSB), CSI-RS, tertiary reference signals (or any other sync signal), positioning RS (PRS), DMRS, phase-tracking reference signals (PTRS), etc. In general, SSB is available to all UEs regardless of RRC state, while other RS (e.g., CSI-RS, DM-RS, PTRS) are associated with specific UEs that have a network connection, i.e., in RRC_CONNECTED state. Such DL RS beams can be correlated and/or coextensive with other beams used to transmit and/or receive physical data channels (e.g., PDSCH, PUSCH) and/or physical control channels (e.g., PDCCH, PUCCH).

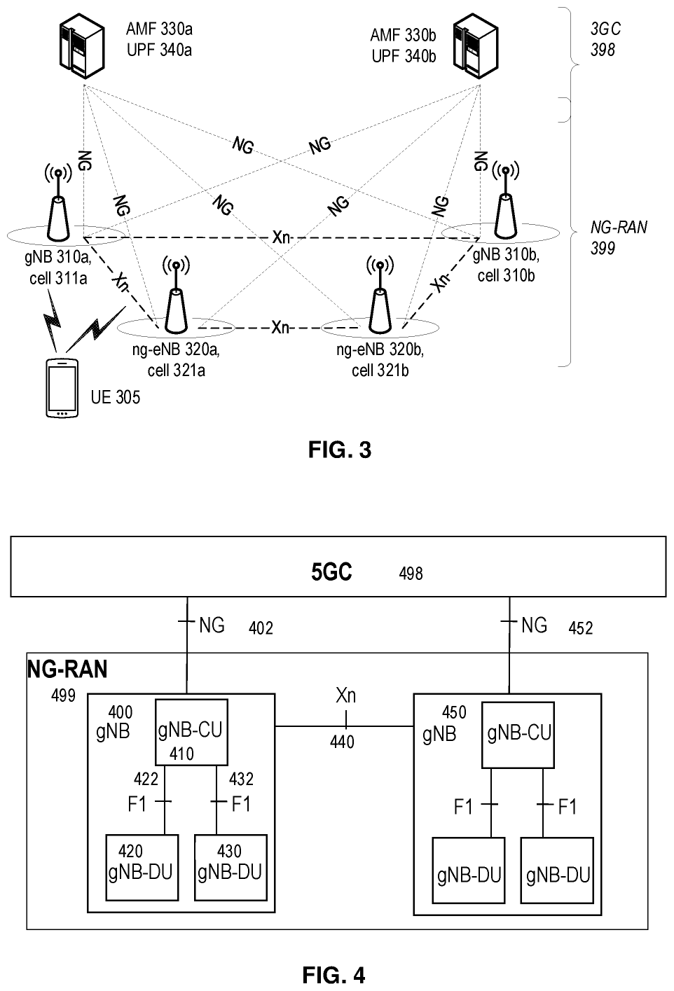

FIG. 3 shows a high-level view of an exemplary 5G network architecture, including a Next Generation Radio Access Network (NG-RAN) 399 and a 5G Core (5GC) 398. As shown in the figure, NG-RAN 399 can include gNBs 310 (e.g., 310a,b) and ng-eNBs 320 (e.g., 320a,b) that are interconnected with each other via respective Xn interfaces. The gNBs and ng-eNBs are also connected via the NG interfaces to 5GC 398, more specifically to the AMF (Access and Mobility Management Function) 330 (e.g., AMFs 330a,b) via respective NG-C interfaces and to the UPF (User Plane Function) 340 (e.g., UPFs 340a,b) via respective NG-U interfaces.

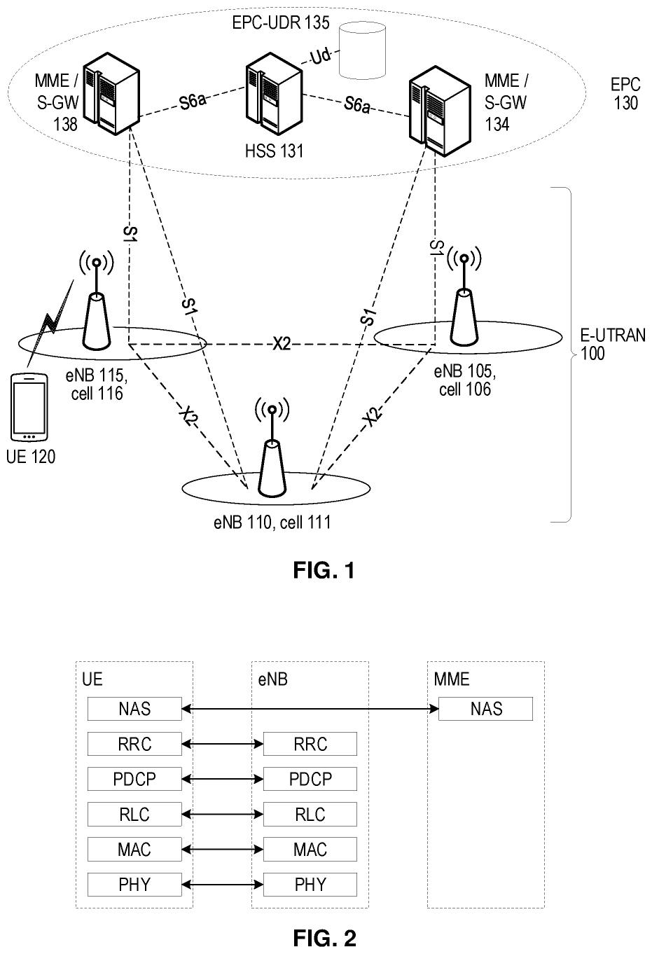

Each of the gNBs 310 can support the NR radio interface, including frequency division duplexing (FDD), time division duplexing (TDD), or a combination thereof. In contrast, each of ng-eNBs 320 supports the LTE radio interface but, unlike conventional LTE eNBs (such as shown in FIG. 1), connect to the 5GC via the NG interface.

Each of the gNBs and ng-eNBs can serve a geographic coverage area including one more cells, including exemplary cells 311a-b and 321a-b shown in FIG. 3. As mentioned above, the gNBs and ng-eNBs can also use various directional beams to provide coverage in the respective cells. Depending on the particular cell in which it is located, a UE 305 can communicate with the gNB or ng-eNB serving that particular cell via the NR or LTE radio interface, respectively. In some cases, the gNBs and ng-eNBs can provide multi-RAT (radio access technology) dual connectivity (MR-DC) to UE 305, e.g., via cells 311a and 321a.

In some implementations, gNBs may also be connected to an LTE eNB via the X2 interface. For example, an LTE eNB connected to an EPC (e.g., as shown in FIG. 1) can connect via the X2 interface with a so called “ne-gNB” that is not connected directly to a core network. In this example, the ne-gNB is connected via X2 to an eNB for the sole purpose of performing and/or providing DC to one or more UEs.

FIG. 4 illustrates another high-level view of an exemplary 5G network architecture. The network shown in FIG. 4 includes NG-RAN 499 and 5GC 498, which can be similar to NG-RAN 399 and 5GC 398 illustrated in FIG. 3. More specifically, NG-RAN 499 can include gNBs connected to the 5GC via one or more NG interfaces, such as gNBs 400, 450 connected via interfaces 402, 452, respectively. In addition, the gNBs can be connected to each other via one or more Xn interfaces, such as Xn interface 440 between gNBs 400 and 450.

In the split-RAN architecture shown in FIG. 4, NG-RAN nodes include a central unit (CU or gNB-CU) and one or more distributed units (DUs or gNB-DUs). For example, gNB 400 in FIG. 4 includes gNB-CU 410 and gNB-DUs 420 and 430. CUs (e.g., gNB-CU 410) are logical nodes that host higher-layer protocols and perform various gNB functions such controlling the operation of DUs. Likewise, DUs are logical nodes that host lower-layer protocols and can include, depending on the functional split, various subsets of the gNB functions. As such, each of the CUs and DUs can include various circuitry needed to perform their respective functions, including processing circuitry, interface and/or transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 422 and 432 shown in FIG. 4. The gNB-CU and connected gNB-DUs are only visible to other gNBs and the 5GC as a gNB, e.g., the F1 interface is not visible beyond gNB-CU. A CU can host higher-layer protocols such as F1 application part protocol (F1-AP), Stream Control Transmission Protocol (SCTP), GPRS Tunnelling Protocol (GTP), Packet Data Convergence Protocol (PDCP), User Datagram Protocol (UDP), Internet Protocol (IP), and Radio Resource Control (RRC) protocol. In contrast, a DU can host lower-layer protocols such as, e.g., Radio Link Control (RLC), Medium Access Control (MAC), and physical-layer (PHY) protocols. However, other variants of protocol distributions between CU and DU are possible.

As mentioned above, the network can configure a UE in RRC_CONNECTED state to perform measurements and send measurement reports to the RAN node that provides the UE's current serving cell. For example, the network can configure a UE to perform measurements on various carrier frequencies and various RATs corresponding to neighbor cells, as well as for various purposes such as mobility and positioning. The configuration for each of these measurements is referred to as a “measurement object.” Furthermore, the UE can be configured to perform the measurements according to a “measurement gap pattern” (or “gap pattern” for short), which can comprise a measurement gap repetition period (MGRP) (i.e., how often a regular gap available for measurements occurs) and a measurement gap length (MGL) (i.e., the length of each gap).

Upon receiving measurement reports that meet predetermined triggering criteria, the serving RAN node may send a handover command to the UE. In LTE, this command is an RRConnectionReconfiguration message with a mobilityControlInfo field. In NR, this command is an RRCReconfiguration message with a reconfigurationWithSync field.

The basic mobility solution in NR shares some similarities to LTE. The UE may be configured by the network to perform cell measurements and report them, to assist the network to take mobility decisions. However, an NR UE may be configured to perform L3 beam measurements based on different reference signals and report them for each cell (serving and non-serving/candidate) fulfilling triggering conditions for measurement report (e.g., an “A3 event”). In particular, NR UEs can be configured to perform/report measurements on SSBs in addition to the reference signals measured/reported by LTE UEs (e.g., CSI-RS). Each SSB is carried in four (4) adjacent OFDM symbols and includes a combination of primary synchronization signal (PSS), secondary synchronization signal (SSS), DM-RS, and physical broadcast channel (PBCH).

As described in 3GPP TS 38.300 (v15.4.0), an NR UE in RRC_CONNECTED state measures one or more detected beams of a cell and then averages the measurements results (e.g., power values) to derive the cell quality. In doing so, the UE is configured to consider a subset of the detected beams. Filtering takes place at two different levels: at the physical layer to derive beam quality and then at RRC level to derive cell quality from multiple beams. Cell quality from beam measurements is derived in the same way for the serving cell(s) and for the non-serving/candidate cell(s). Measurement reports may contain the measurement results of the Xbest beams if the UE is configured to do so by the gNB.

In making handover (and, more generally, mobility) decisions for individual UEs, the network takes into account not only the UE-reported measurements but also the load of the respective cells in the network. In the present disclosure, the term “load” (or equivalently “load information” or “load-related information”) can refer to a measure of resources being consumed (e.g., by the respective cells) or a measure of an available capacity (e.g., remaining in the respective cells). The loads of cells served by a radio access node are typically measured frequently. When the load of a cell exceeds a pre-configured threshold, procedures can be triggered to transfer some UE traffic from the overloaded cell to either a neighbor cell of the same radio access technology (RAT), a different RAT, a different frequency, etc.

Put differently, a mobility load balancing (MLB) algorithm running at a radio access node (e.g., eNB or gNB) has to decide which UEs will be handed over (“UE selection”) and to which neighbor cells (“cell selection”). These decisions are typically made based on the load reports and any available radio measurements of source cell and neighbor cells, such as measurements reported by UEs operating in RRC_CONNECTED and RRC_IDLE states.

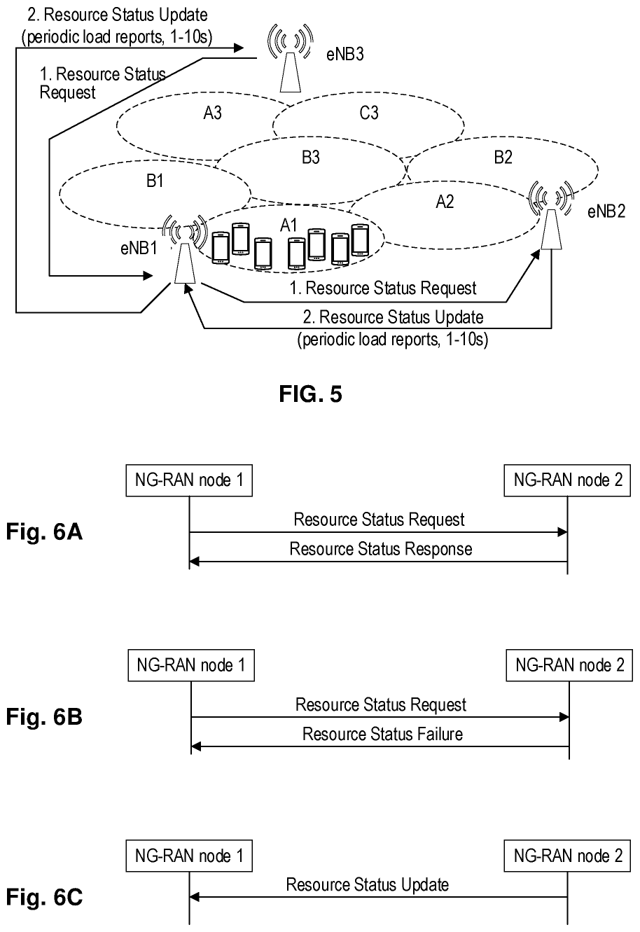

Network load balancing is based on various procedures used by RAN nodes to exchange load and capacity information over interfaces. FIG. 5 illustrates an exemplary LTE load-balancing scenario involving three (3) eNBs. In this scenario, eNB1 serves cells A1 and B1, eNB2 serves cells A2 and B2, and eNB3 serves cells A3, B3, and C3. Furthermore, eNB2 and eNB3 periodically report load values for their served cells to eNB1. This reporting is initiated by eNB1 sending Resource Status Request messages to eNB1 and eNB2 (operation 1), which respond with respective Resource Status Update messages that include periodic load reports.

In addition, UEs operating in a cell served by eNB1 (e.g., A1) may send measurement reports (RSRP, RSRQ, SINR, etc.) to eNB1 for one or more neighbour cells (e.g. A2, B3). Based on these reports and the received load information for neighbor cells, eNB1 may decide to handover one or more UE from Al to a neighbour cell such as B3 or A2. When eNB1 decides to offload a UE (e.g., to A2), it triggers an ordinary handover, including a handover preparation with a selected target node (e.g., eNB2).

For NR networks, examples of Resource Status Reporting initiation procedures between NG-RAN nodes over the Xn interface are shown in FIGS. 6A (successful) and FIG. 6B (unsuccessful) and are described in 3GPP contribution R3-197763, of which the following is an excerpt:

****Begin Excerpt From 3GPP Document****

### 8.4.A Resource Status Reporting Initiation

Editor's note: The content of this section is FFS

### 8.4.A.1 General

This procedure is used by an NG-RAN node₁ to request the reporting of load measurements to another NG-RAN node₂. The procedure uses non UE-associated signalling.

### 8.4.A.2 Successful Operation

The procedure is initiated with a RESOURCE STATUS REQUEST message sent from NG-RAN node₁ to NG-RAN node₂ to start a measurement, stop a measurement or add cells to report for a measurement. Upon receipt, NG-RAN node₂:
shall initiate the requested measurement according to the parameters given in the request in case the Registration Request IE set to “start”; or
shall stop all cells measurements and terminate the reporting in case the Registration Request IE is set to “stop”; or
add cells indicated in the Cell To Report IE list to the measurements initiated before for the given measurement IDs, in case the Registration Request IE is set to “add”.
   Interaction with Other Procedures

When starting a measurement, the Report Characteristics IE in the RESOURCE STATUS REQUEST indicates the type of objects NG-RAN node₂ shall perform measurements on. For each cell, the NG-RAN node₂ shall include in the RESOURCE STATUS UPDATE message:
[This paragraph is FFS] the Radio Resource Status IE, if the first bit, “PRB Periodic” of the Report Characteristics IE included in the RESOURCE STATUS REQUEST message is set to 1. If the NG-RAN node₂ is a gNB and if the cell for which Radio Resource Status IE is requested to be reported supports more than one SSB, the Radio Resource Status IE for such cell shall include the SSB Area Radio Resource Status Item IE for all SSB areas supported by the cell. If the SSB To Report List IE is included for a cell, the Radio Resource Status IE for such cell shall include the requested SSB Area Radio Resource Status List IE.
The NG TNL Capacity Indicator IE, if the second bit, “TNL Capacity Ind Periodic” of the Report Characteristics IE included in the RESOURCE STATUS REQUEST message is set to 1;
The Composite Available Capacity Group IE, if the third bit, “Composite Available Capacity Periodic” of the Report Characteristics IE included in the RESOURCE STATUS REQUEST message is set to 1. If Cell Capacity Class Value IE is included within the Composite Available Capacity Group IE, this IE is used to assign weights to the available capacity indicated in the Capacity Value IE. If the NG-RAN node₂ is a gNB and if the cell for which Composite Available Capacity Group IE is requested to be reported supports to more than one SSB, and if the SSB To Report List IE is included for a cell, the Composite Available Capacity Group IE for such cell shall include the requested SSB Area Capacity Value List IE, providing the SSB area capacity with respect to the Cell Capacity Class Value.
If the cell for which Composite Available Capacity Group IE is requested to be reported supports more than one slice, and if the Slice To Report List IE is included for a cell, the Composite Available Capacity Group IE for such cell shall include the required Slice Available Capacity IE, providing the slice capacity with respect to the Cell Capacity Class Value.
The RRC Connections IE, if the sixth bit, “RRC Connections” of the Report Characteristics IE included in the RESOURCE STATUS REQUEST message is set to 1.

### 8.4.A.3 Unsuccessful Operation

If none of the requested measurements can be initiated, NG-RAN node₂ shall send a RESOURCE STATUS FAILURE message.

### 8.4.A.4 Abnormal Conditions

### 8.4.A.4 Abnormal Conditions

For further study (FFS)

### ****End Excerpt From 3GPP Document****

An example of Resource Status Update procedures used by NG-RAN nodes (e.g., after a successful initiation procedure described above) over the Xn interface is shown in FIG. 6C and is described in 3GPP contribution R3-197763, of which the following is an excerpt:

### ****Begin Excerpt From 3GPP Document****

### 8.4.B Resource Status Reporting

Editor's note: The content of this section is FFS

### 8.4.B.1 General

This procedure is initiated by NG-RAN node₂ to report the result of measurements admitted by NG-RAN node₂ following a successful Resource Status Reporting Initiation procedure. The procedure uses non UE-associated signalling.

### 8.4.B.2 Successful Operation

The NG-RAN node₂ shall report the results of the admitted measurements in RESOURCE STATUS UPDATE message. The admitted measurements are the measurements that were successfully initiated during the preceding Resource Status Reporting Initiation procedure.

### ****End Excerpt From 3GPP Document****

In addition, the message structure used for the Resource Status Update are defined in 3GPP contribution R3-197763, of which the following is an excerpt:

### ****Begin Excerpt From 3GPP Document****

### 9.1.3.D Resource Status Update

Editor's note: The content of this section is FFS

This message is sent by NG-RAN node₂ to neighbouring NG-RAN node₁ to report the results of the requested measurements.

Direction: NG-RAN node₂→NG-RAN node₁.

| | | | | Semantics |
|---|---|---|---|---|
| IE/Group Name | Presence | Range | IE type/ref. | description |
| Message Type | M | | 9.2.3.1 | |
| NG-RAN node1 | M | | INTEGER | Allocated by |
| Measurement ID | | | (1 . . . 4095, . . . ) | NG-RAN node₁ |
| NG-RAN node2 | M | | INTEGER | Allocated by |
| Measurement ID | | | (1 . . . 4095, . . . ) | NG-RAN node₂ |
| Hardware Load | O | | 9.2.ww | |
| Indicator [FFS] | | | | |
| Cell Measurement | | 1 | | |
| Result | | | | |
| >Cell Measurement | | 1 . . . | | |
| Result Item | | < maxnoofCellsinNG-RANnode > | | |
| >>Cell ID | M | | 9.2.3.25 | |
| >>Radio Resource | O | | 9.2.yy | |
| Status [FFS] | | | | |
| >>NG TNL Load | O | | 9.2.xx | |
| Indicator [It is FFS | | | | |
| if reported per cell] | | | | |
| >>Composite | O | | 9.2.zz | |
| Available Capacity | | | | |
| Group | | | | |
| >>Slice Available | O | | 9.2.jj | |
| Capacity [FFS] | | | | |
| >>Number of | O | | INTEGER | |
| Active UEs [FFS] | | | (1 . . . 65536, . . . ) | |
| >>RRC | O | | 9.2.kk | |
| Connections | | | | |

| Range bound | Explanation |
|---|---|
| maxnoofCellsinNG-RANnode | Maximum no. cells that can be served |
| | by a NG-RAN node. Value is 16384. |

### 9.2.xx NG TNL Capacity Indicator

The NG TNL Capacity Indicator IE indicates the offered and available capacity of the NG Transport Network.

| IE/Group Name | Presence | Range | IE type/ref. | Semantics description |
|---|---|---|---|---|
| DL NGTNL | M | | INTEGER (1 . . . 16777216, . . . ) | Maximum capacity |
| Offered Capacity | | | | offered by the transport |
| | | | | portion of the NG-gNB in |
| | | | | kbps |
| DL NGTNL | M | | INTEGER (1 . . . 100, . . . ) | Available capacity over |
| Available | | | | the transport portion of |
| Capacity | | | | the NG-gNB in |
| | | | | percentage. Value 100 |
| | | | | corresponds to the offered |
| | | | | capacity. |
| UL NGTNL | M | | INTEGER (1 . . . 16777216, . . . ) | Maximum capacity |
| Offered Capacity | | | | offered by the transport |
| | | | | portion of the NG-gNB in |
| | | | | kbps |
| UL NGTNL | M | | INTEGER (1 . . . 100, . . . ) | Available capacity over |
| Available | | | | the transport portion of |
| Capacity | | | | the NG-gNB in |
| | | | | percentage. Value 100 |
| | | | | corresponds to the offered |
| | | | | capacity. |

### 9.2.yy Radio Resource Status

[The information is FFS]

The Radio Resource Status IE indicates the usage of the PRBs per cell and per SSB area for all traffic in Downlink and Uplink and the usage of PDCCH CCEs for Downlink and Uplink scheduling.

| | | | | Semantics |
|---|---|---|---|---|
| IE/Group Name | Presence | Range | IE type/ref. | description |
| CHOICE Radio Resource | M | | | |
| Status Type | | | | |
| >ng-eNB | | | | |
| >>DL GBR PRB usage | M | | INTEGER (0 . . . 100) | Per cell DL GBR |
| | | | | PRB usage |
| >>UL GBR PRB usage | M | | INTEGER (0 . . . 100) | Per cell UL GBR |
| | | | | PRB usage |
| >>DL non-GBR PRB | M | | INTEGER (0 . . . 100) | Per cell DL non- |
| usage | | | | GBR PRB usage |
| >>UL non-GBR PRB | M | | INTEGER (0 . . . 100) | Per cell UL non- |
| usage | | | | GBR PRB usage |
| >>DL Total PRB usage | M | | INTEGER (0 . . . 100) | Per cell DL Total |
| | | | | PRB usage |
| >>UL Total PRB usage | M | | INTEGER (0 . . . 100) | Per cell UL Total |
| | | | | PRB usage |
| >>DL scheduling PDCCH | O | | INTEGER (0 . . . 100) | |
| CCE usage | | | | |
| >>UL scheduling PDCCH | O | | INTEGER (0 . . . 100) | |
| CCE usage | | | | |
| >gNB | | | | |
| >>SSB Area Radio | | 0 . . . 1 | | |
| Resource Status List | | | | |
| >>>SSB Area Radio | | l . . . | | |
| Resource Status Item | | <maxnoofSSBAreas> | | |
| >>>> SSB Area DL | M | | INTEGER (0 . . . 100) | Per SSB area DL |
| GBR PRB usage | | | | GBR PRB usage |
| >>>> SSB Area UL | M | | INTEGER (0 . . . 100) | Per SSB area UL |
| GBR PRB usage | | | | GBR PRB usage |
| >>>> SSB Area DL | M | | INTEGER (0 . . . 100) | Per SSB area DL |
| non-GBR PRB usage | | | | non-GBR PRB |
| | | | | usage |
| >>>> SSB Area UL | M | | INTEGER (0 . . . 100) | Per SSB area UL |
| non-GBR PRB usage | | | | non-GBR PRB |
| | | | | usage |
| >>>> SSB Area DL | M | | INTEGER (0 . . . 100) | Per SSB area DL |
| Total PRB usage | | | | Total PRB usage |
| >>>> SSB Area UL | M | | INTEGER (0 . . . 100) | Per SSB area UL |
| Total PRB usage | | | | Total PRB usage |
| >>DL scheduling PDCCH | O | | INTEGER (0 . . . 100) | |
| CCE usage | | | | |
| >>UL scheduling PDCCH | O | | INTEGER (0 . . . 100) | |
| CCE usage | | | | |

| Range bound | Explanation |
|---|---|
| maxnoofSSBAreas | Maximum no. SSB Areas that can be served |
| | by a NG-RAN node cell. Value is 64. |

### 9.2.zz Composite Available Capacity Group

The Composite Available Capacity Group IE indicates the overall available resource level per cell and per SSB area in the cell in Downlink and Uplink.

| | | | | Semantics |
|---|---|---|---|---|
| IE/Group Name | Presence | Range | IE type/ref. | description |
| Composite Available | M | | Composite | For |
| Capacity Downlink | | | Available | Downlink |
| | | | Capacity 9.2.a | |
| Composite Available | M | | Composite | For Uplink |
| Capacity Uplink | | | Available | |
| | | | Capacity 9.2.a | |

### 9.2.a Composite Available Capacity

The Composite Available Capacity IE indicates the overall available resource level in the cell in either Downlink or Uplink.

| IE/Group Name | Presence | Range | IE type/ref. | Semantics description |
|---|---|---|---|---|
| Cell Capacity | O | | 9.2.b | |
| Class Value | | | | |
| Capacity Value | M | | 9.2.c | ‘0’ indicates no |
| | | | | resource is available, |
| | | | | Measured on |
| | | | | a linear scale. |

### 9.2.b Cell Capacity Class Value

The Cell Capacity Class Value IE indicates the value that classifies the cell capacity with regards to the other cells. The Cell Capacity Class Value IE only indicates resources that are configured for traffic purposes.

| IE/Group Name | Presence | Range | IE type/ref. | Semantics description |
|---|---|---|---|---|
| Capacity Class | M | | INTEGER | Value 1 shall indicate the |
| Value | | | (1 . . . 100, . . . ) | minimum cell capacity, and 100 |
| | | | | shall indicate the maximum cell |
| | | | | capacity. There should be a linear |
| | | | | relation between cell capacity and |
| | | | | Cell Capacity Class Value. |

### 9.2.c Capacity Value

The Capacity Value IE indicates the amount of resources per cell and per SSB area that are available relative to the total NG-RAN resources. The capacity value should be measured and reported so that the minimum NG-RAN resource usage of existing services is reserved according to implementation. The Capacity Value IE can be weighted according to the ratio of cell capacity class values, if available.

| | | | IE | |
|---|---|---|---|---|
| IE/Group Name | Presence | Range | type/ref. | Semantics description |
| Capacity Value | M | | INTEGER | Value 0 shall indicate no |
| | | | (0 . . . 100) | available capacity, and 100 shall |
| | | | | indicate maximum available |
| | | | | capacity with respect to the |
| | | | | whole cell. Capacity Value |
| | | | | should be measured on a linear |
| | | | | scale. |
| SSB Area Capacity | | 0 . . . 1 | | |
| Value List | | | | |
| >SSB Area | | 0 . . . | | |
| Capacity Value | | <maxnoofSSBAreas> | | |
| Item | | | | |
| >> SSB Area | M | | INTEGER | Value 0 shall indicate no |
| Capacity Value | | | (0 . . . 100) | available capacity, and 100 shall |
| | | | | indicate maximum available |
| | | | | capacity . SSB Area Capacity |
| | | | | Value should be measured on a |
| | | | | linear scale. |

### 9.2.jj Slice Available Capacity

The Slice Available Capacity IE indicates the amount of resources per network slice that are available relative to the total NG-RAN resources. The Slice Capacity Value IE can be weighted according to the ratio of cell capacity class values, if available.

| | | | IE | |
|---|---|---|---|---|
| IE/Group Name | Presence | Range | type/ref. | Semantics description |
| Slice Available | | 1 . . . | | |
| Capacity | | < maxnoofSliceitems > | | |
| > Slice | M | | INTEGER | Value 0 shall indicate no |
| Capacity Value | | | (0 . . . 100) | available capacity, and 100 shall |
| | | | | indicate maximum available |
| | | | | capacity . Slice Capacity Value |
| | | | | should be measured on a linear |
| | | | | scale. |

| Range bound | Explanation |
|---|---|
| maxnoofSliceltems [FFS] | Maximum no. of signaled slice support |
| | items. Value is 1024. [FFS] |

### ****End Excerpt From 3GPP Document****

As illustrated in the above details of the load information exchange messaging between RAN nodes, load/capacity information such as resource utilization and available capacity can be provided and/or exchanged on a per-cell basis or per-beam area basis within a cell. However, such information does not adequately represent the capacity available at neighbouring RAN nodes when UEs are configured for CA with multiple carriers.

For example, a UE can be configured with carriers of different cells at the same time. The capacity available to a UE in such a configuration is the sum of the capacity available in each cell that is part of the CA configuration. However, current solutions only allow a neighbour RAN node to know the capacity of a single cell or beam area within a cell. Limited to such information, the neighbour RAN node is unable to determine whether carriers of two or more cells can be used for UE configurations, such as for CA or dual connectivity (DC). As such, the neighbour RAN node may make an incorrect and/or suboptimal load balancing decision because it lacks a clear understanding of the capacity available at a neighbour cell that can be used for a CA configuration for the UE.

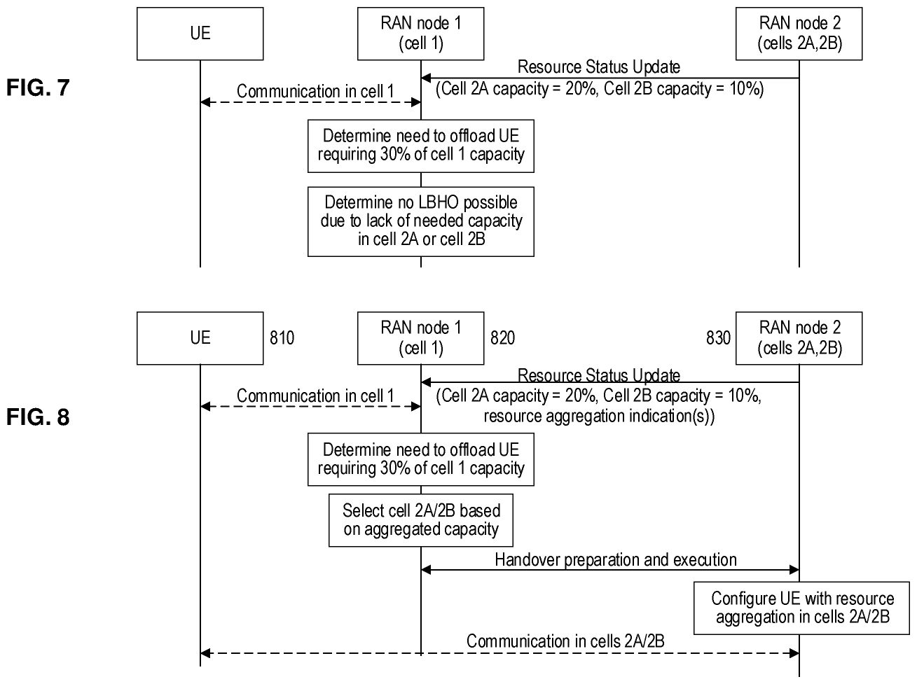

FIG. 7 shows an exemplary scenario that illustrates certain load-balancing issues, difficulties, and/or problems related to CA configurations. In the scenario shown in FIG. 7, RAN node 1 provides a serving cell (cell 1) for a UE, while cells 2A and 2B are neighbour cells of the serving cell. UEs in cells 2A and 2B can be configured with CA and use all available capacity in these cells. RAN node 2 sends a Resource Status Update to RAN node 1 indicating that cell 2A available capacity is 20% and cell 2B available capacity is 10%.

RAN node 1 determines that it needs to offload the UE, whose services require 30% of cell 1's capacity (e.g., resources). Based on the information received in the Resource Status Update, however, RAN node 1 is unable to trigger a load balancing handover (LBHO) of the UE because neither cell 2A nor cell 2B has enough individual capacity (e.g., available resources) to serve the UE, and RAN node 1 is unaware of the CA capabilities of these two cells.

Exemplary embodiments of the present disclosure address these and other problems, difficulties, and/or issues by providing specific enhancements and/or improvements to load balancing in wireless networks. In general, exemplary embodiments include techniques and/or mechanisms that facilitate exchanging between RAN nodes information about per-cell load and capacity and, when a UE is connected to a particular cells, whether the UE can be configured such that resources provided by other cells can be used at the same time, e.g. via the same set of bearers provided to the UE by the RAN. While these embodiments are described in the context of CA being the mechanism for aggregating resources from different cells, embodiments are also applicable to other techniques used to aggregate multi-cell resources for a given UE, such as dual connectivity (DC).

As such, the disclosed embodiments enable and/or facilitate a RAN node (e.g., gNB) to more efficiently exploit the capacity available in cells served by neighbor RAN nodes, by taking into account the possibility that a UE can be served by aggregating resources from different cells if the UE were handed over for load balancing. This can lead to better load balancing decisions and more effective resource utilization in the RAN (e.g., E-UTRAN or NG-RAN).

At a high level, embodiments include a second RAN node providing, indicating, and/or signaling any of the following information, to a first RAN node, about cells served by the first RAN node:
An indication that two or more cells can be used for resource aggregation configurations (e.g., CA or DC) for a UE. An example of when this information can be signaled is when such cells completely overlap, whereby UE is simultaneously in coverage of all of them.
An indication that two or more cells are overlapping such that a UE can be configured with resource aggregation (e.g., CA or DC) for all cells in the region of coverage overlap. As a variant, a level or degree of overlap (e.g., full, partial, percentage, etc.) can also be indicated.
An indication that two or more cells are served by the same gNB-DU. This can facilitate CA configurations using different cells, according to 3GPP specifications. In particular, a UE can be configured with CA using two or more cells only if these cells are served by the same gNB-DU.
An indication that two or more cells served by different gNB-DUs can be used for CA configurations. This information can be used in network architectures that allow the establishment of CA configurations between cells served by different gNB-DUs.

The above indications can be signalled individually or in combination. For example, the second RAN node can provide an indication that two cells are served by the same gNB-DU or by two different gNB-DUs, but can further indicate that the two cells can be used for configuration of CA for the same UE, together with an indication of the level of overlap between the cells.

At a high level, embodiments also include the first RAN node determining the overall capacity available for offloading UEs to cells served by the second RAN node, based on any of the above-described resource aggregation information received from the second RAN node. Such determinations can also be based on load/capacity information for the individual cells, as well as whether UE candidates for load-balancing handover to cells served by the second RAN node support resource aggregation configurations (e.g., CA and/or DC). Furthermore, such embodiments also include the first RAN node making load balancing UE mobility decisions based on the second RAN node's cell capacity determined in this manner.

FIG. 8 shows an exemplary load-balancing scenario that illustrates various embodiments of the present disclosure. Like the scenario shown in FIG. 7, RAN node 1 (820) provides a serving cell for a UE (810) and RAN node 2 (830) provides cells 2A and 2B that are neighbor cells of the serving cell. UEs served by cells 2A-2B can be configured with CA and use all available capacity in both of these cells.

Initially, RAN node 2 sends a Resource Status Update to RAN node 1 (e.g., via an Xn interface between the two nodes) indicating that cell 2A available capacity is 20% and cell 2B available capacity is 10%. RAN node 2 can also include in the Resource Status Update one or more of the following resource aggregation indications:
that cell 2A and cell 2B overlap in full;
that cell 2A and cell 2B overlap partially (optionally a degree of partial overlap);
that cell 2A and cell 2B are served by the same gNB-DU;
that cell 2A and cell 2B are served by different gNB-DUs but that resources from the cells can be aggregated (e.g., via CA or DC) to serve UEs that are handed over; and/or
that resource aggregation (e.g., via CA or DC) is possible between cell 2A and cell 2B, which can be independent of whether they are served by the same DU.

In some embodiments, any of the above indications can be provided by RAN node 2 to RAN node 1 during setup of the Xn (or X2) interface between the two nodes. Alternately, any of the above indications can be included in other messages between the two RAN nodes, e.g., any messages relating to cell 2A and/or cell 2B. In such embodiments, RAN node 1 can combine relevant information received at Xn interface setup with relevant information received via Resource Status Update to determine the overall capacity potentially available at a target cell in view of resource aggregation capabilities.

As mentioned above, the resource aggregation indications provided by RAN node 2 can include a level or degree of overlap between two or more cells. For example, an index from 0 to 100 can be provided, with 0 indicating no overlap, 100 indicating full overlap, and intermediate values indicating degrees of partial overlap (e.g., percentage of overlap). Other values and/or ranges can be employed.

In other related embodiments, RAN node 2 can provide an estimation of the likelihood that a UE would be provided a resource aggregation (e.g., CA or DC) configuration involving cell 2A and cell 2B if the UE were to be handed over. An index from 0 to 100 can be provided in a similar manner as described above, with 0 indicating no likelihood, 100 indicating certainty, and intermediate values indicating degrees of likelihood or uncertainty. Other values and/or ranges can be employed

Subsequently, RAN node 1 can determine a need to offload the UE, which requires 30% of the capacity in cell 1. RAN node 1 can use the resource aggregation indication(s) previously received from RAN node 2 to perform one or more of the following:
determine the overall capacity available for offloading UEs to cells served by RAN node 2, including cell 2A and/or cell 2B;
determine whether any resource aggregation configuration involving cells of RAN node 2 (e.g., cell 2A and/or cell 2B) is possible if the UE is handed over to RAN node 2;
determine whether to handover the UE to a cell served by RAN node 2 (e.g., cell 2A or cell 2B); and
determine one or more other UEs to be handed over to cells served by RAN node 2 for purposes of load balancing.

In some embodiments, RAN node 1 can also base these determinations on load and/or capacity information for cell 2A and/or cell 2B, such as per-cell and/or per-beam coverage in the respective cells, as described above. In some embodiments, RAN node 1 can also base this determination on measurements on cells 2A and/or 2B (and/or beams in the respective cells) that were made and reported by UEs served by RAN node 1. In some embodiments, RAN node 1 can also base this determination on whether UE candidates for load-balancing handover to cells served by RAN node 2 support resource aggregation configurations (e.g., CA and/or DC).

If the information provided by RAN node 2 includes an indication of the likelihood that the UE will be provided with a configuration involving resource aggregation (e.g., CA or DC) from cells 2A-2B, RAN node 1 can use such likelihood information to decide whether to handover the UE to one of cell 2A or cell 2B, depending on HO decision policies. For example, the indication can be a direct indication of the likelihood of resource aggregation, an indirect indication (e.g., of the level of overlap between cell 2A and cell 2B), or any similar indication related to likelihood of utilisation of resources from both cells to serve the UE.

Based on any of this information, RAN node 1 can select cells 2A-2B for a LBHO of the UE. RAN node 1 proceeds with HO preparation and execution with RAN node 2, which configures the UE to use resources aggregated from cells 2A-2B for post-HO communications.

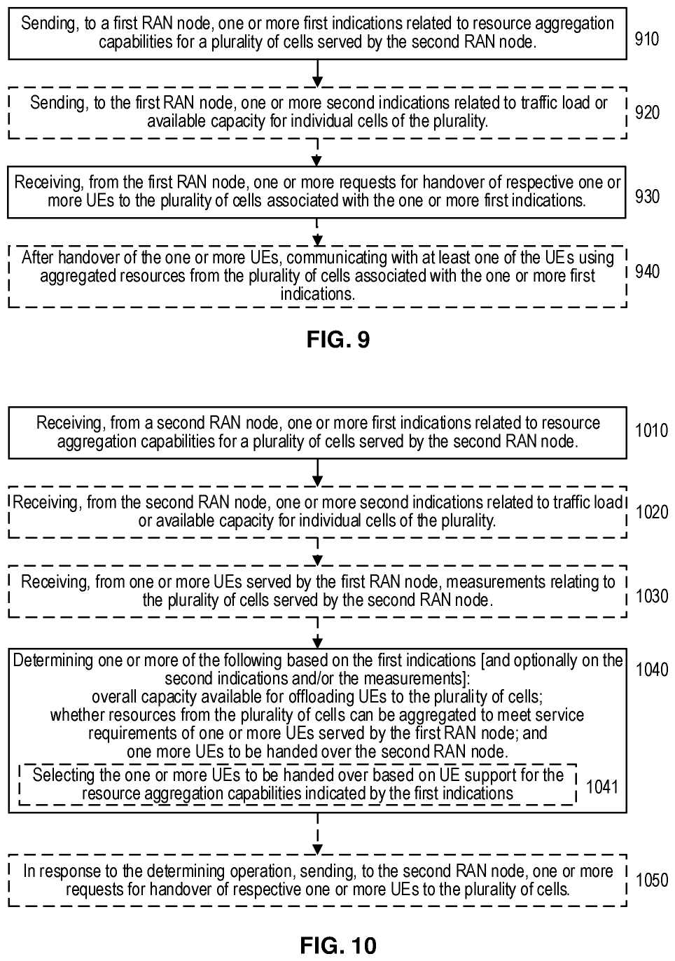

These embodiments described above can be further illustrated with reference to FIGS. 9-10, which depict exemplary methods (e.g., procedures) for load balancing between a first RAN and a second RAN node. In other words, various features of the operations described below with reference to FIGS. 9-10 correspond to various embodiments described above. The exemplary methods shown in FIGS. 9-10 can be used cooperatively to provide various benefits, advantages, and/or solutions to problems described herein. Although the exemplary methods are illustrated by specific blocks in particular orders, the operations of the exemplary methods can be performed in different orders than shown and can be combined and/or divided into blocks having different functionality than shown. Optional blocks or operations are indicated by dashed lines.

Specifically, FIG. 9 illustrates an exemplary method (e.g., procedure) that can be performed by the second RAN node (e.g., base station, eNB, gNB, ng-eNB, etc., or component thereof), such as a RAN node configured as described herein with reference to other figures.

The exemplary method can include the operations of block 910, where the second RAN node can send, to the first RAN node, one or more first indications related to resource aggregation capabilities for a plurality of cells served by the second RAN node. In some embodiments, the resource aggregation capabilities can include carrier aggregation (CA) and/or dual connectivity (DC). In various embodiments, the first indications can include one or more of the following indications (discussed in more detail above):
that resources from the plurality of cells can be aggregated to serve a UE that is handed over to the second RAN node;
an estimated likelihood (e.g., 0-100) that resources from the plurality of cells can be aggregated to serve a UE that is handed over to the second RAN node;
that the plurality of cells overlap in coverage;
a degree of overlap (e.g., 0-100) in coverage between the plurality of cells; and
whether the plurality of cells are served by the same distributed unit (DU) or different DUs associated with the second RAN node.

In some embodiments, the first indications are sent in a single message. For example, the first and second RAN nodes can be gNBs in an NG-RAN. In such embodiments, the first indications can be sent in a Resource Status Update message over an Xn (or X2) interface between the first and second RAN nodes. In other embodiments, a first portion of the first indications can be sent during setup of an interface (e.g., Xn or X2) between the first and second RAN nodes, and a second portion of the first indications can be sent after the interface is setup (e.g., in a Resource Status Update).

In some embodiments, the exemplary method can also include the operations of block 920, where the second RAN node can send, to the first RAN node, one or more second indications related to traffic load or available capacity for individual cells of the plurality. For example, as illustrated in FIG. 8, the second RAN node can indicate a percentage of capacity available in each of the cells. The one or more second indications can be sent in a separate message (e.g., Resource Status Update) or in the same message as the first indications.

The exemplary method can also include the operations of block 930, where the second RAN node can receive, from the first RAN node, one or more requests for handover of respective one or more UEs to the plurality of cells associated with the one or more first indications. These handover requests can be for load balancing, as facilitated by the first indications sent in block 910 and optionally the second indications sent in block 920.

In some embodiments, the exemplary method can also include the operations of block 940, where after handover of the one or more UEs, the second RAN node can communicate with at least one of the UEs using aggregated resources from the plurality of cells associated with the one or more first indication. Note that the second RAN node may not use aggregated resources to communicate with all UEs being handed over. In some cases, the second RAN node can use single-cell resources to communicate with some of the UEs and aggregated resources to communicate with other of the UEs. For example, a UE may be handed over to one of the plurality of cells that does not overlap, or whose resources do not easily aggregate, with others of the plurality of cells. This can be conveyed by the specific first indications sent by the second RAN node, e.g., estimated likelihood, degree of overlap, etc.

In addition, FIG. 10 illustrates an exemplary method (e.g., procedure) that can be performed by the first RAN node (e.g., base station, eNB, gNB, ng-eNB, etc., or component thereof), such as a RAN node configured as described herein with reference to other figures.

The exemplary method can include the operations of block 1010, where the first RAN node can receive, from the second RAN node, one or more first indications related to resource aggregation capabilities for a plurality of cells served by the second RAN node. In some embodiments, the resource aggregation capabilities can include CA and/or DC. In various embodiments, the first indications can include one or more of the following indications (discussed in more detail above):
that resources from the plurality of cells can be aggregated to serve a UE that is handed over to the second RAN node;
an estimated likelihood (e.g., 0-100) that resources from the plurality of cells can be aggregated to serve a UE that is handed over to the second RAN node;
that the plurality of cells overlap in coverage;
a degree of overlap (e.g., 0-100) in coverage between the plurality of cells; and
whether the plurality of cells are served by the same distributed unit (DU) or different DUs associated with the second RAN node.

In some embodiments, the first indications can be received in a single message. For example, the first and second RAN nodes can be gNBs in an NG-RAN. In such embodiments, the first indications can be received in a Resource Status Update message over an Xn (or X2) interface between the first and second RAN nodes. In other embodiments, a first portion of the first indications can be received during setup of an interface (e.g., Xn or X2) between the first and second RAN nodes, and a second portion of the first indications can be received after the interface is setup (e.g., in a Resource Status Update).

In some embodiments, the exemplary method can also include the operations of block 1020, where the first RAN node can receive, from the second RAN node, one or more second indications related to traffic load or available capacity for individual cells of the plurality. For example, as illustrated in FIG. 8, the second RAN node can indicate a percentage of capacity available in each of the cells. The one or more second indications can be received in a separate message (e.g., Resource Status Update) or in the same message as the first indications.

In some embodiments, the exemplary method can also include the operations of block 1030, where the second RAN node can receive, from one or more UEs served by the first RAN node, measurements relating to the plurality of cells served by the second RAN node. Examples of such UE measurements are described in more detail above.

The exemplary method can also include the operations of block 1040, where the first RAN node can determine one or more of the following based on the first indications: overall capacity available for offloading UEs to the plurality of cells; whether resources from the plurality of cells can be aggregated to meet service requirements of one or more UEs served by the first RAN node; and one more UEs to be handed over the second RAN node. In some embodiments, the determining operations in block 1040 can be based on other information, such as the second indications received in block 1020 and/or the UE measurements received in block 1030.

In some embodiments, the determining operations of block 1040 can include the operations of sub-block 1041, where the first RAN node can select the one or more UEs to be handed over based on UE support for the resource aggregation capabilities indicated by the first indications

In some embodiments, the exemplary method can also include the operations of block 1050, where the second RAN node can, in response to the determining operation (e.g., block 1040), send to the second RAN node one or more requests for handover of respective one or more UEs to the plurality of cells associated with the one or more first indications. These handover requests can be for load balancing, as facilitated by the first indications received in block 1010 and optionally the information received in blocks 1020 and/or 1030.

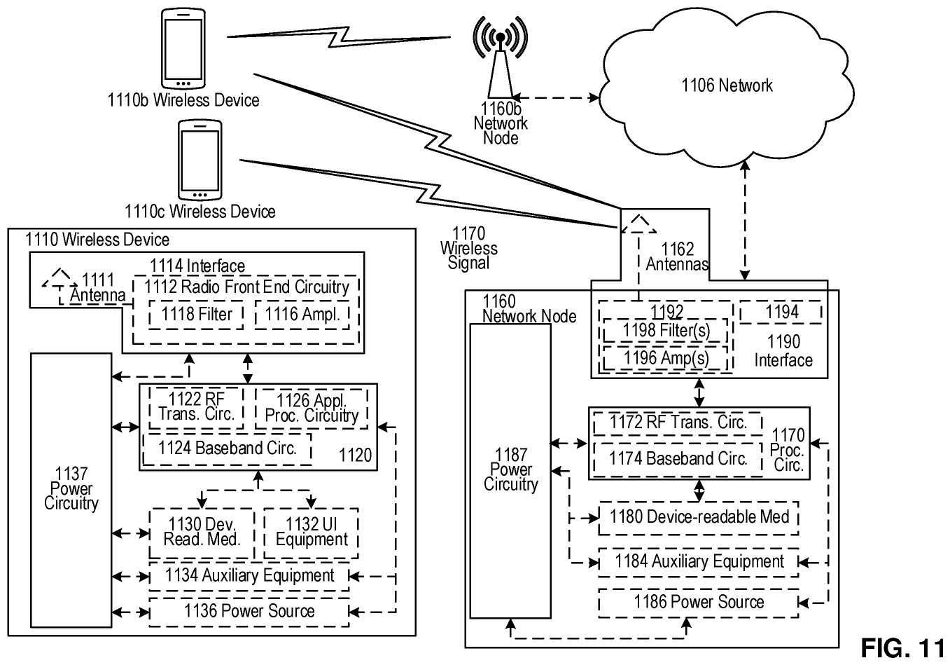

Although the subject matter described herein can be implemented in any appropriate type of system using any suitable components, the embodiments disclosed herein are described in relation to a wireless network, such as the example wireless network illustrated in FIG. 11. For simplicity, the wireless network of FIG. 11 only depicts network 1106, network nodes 1160 and 1160b, and WDs 1110, 1110b, and 1110c. In practice, a wireless network can further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network can provide communication and other types of services to one or more wireless devices to facilitate the wireless devices' access to and/or use of the services provided by, or via, the wireless network.

The wireless network can comprise and/or interface with any type of communication, telecommunication, data, cellular, and/or radio network or other similar type of system. In some embodiments, the wireless network can be configured to operate according to specific standards or other types of predefined rules or procedures. Thus, particular embodiments of the wireless network can implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 can comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network can comprise any number of wired or wireless networks, network nodes, base stations, controllers, wireless devices, relay stations, and/or any other components or systems that can facilitate or participate in the communication of data and/or signals whether via wired or wireless connections.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below. More generally, however, network nodes can represent any suitable device (or group of devices) capable, configured, arranged, and/or operable to enable and/or provide a wireless device with access to the wireless network or to provide some service to a wireless device that has accessed the wireless network.

In FIG. 11, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 11 can represent a device that includes the illustrated combination of hardware components, other embodiments can comprise network nodes with different combinations of components. It is to be understood that a network node comprises any suitable combination of hardware and/or software needed to perform the tasks, features, functions and methods and/or procedures disclosed herein. Moreover, while the components of network node 1160 are depicted as single boxes located within a larger box, or nested within multiple boxes, in practice, a network node can comprise multiple different physical components that make up a single illustrated component (e.g., device readable medium 1180 can comprise multiple separate hard drives as well as multiple RAM modules).

Similarly, network node 1160 can be composed of multiple physically separate components (e.g., a NodeB component and a RNC component, or a BTS component and a BSC component, etc.), which can each have their own respective components. In certain scenarios in which network node 1160 comprises multiple separate components (e.g., BTS and BSC components), one or more of the separate components can be shared among several network nodes. For example, a single RNC can control multiple NodeB's. In such a scenario, each unique NodeB and RNC pair, can in some instances be considered a single separate network node. In some embodiments, network node 1160 can be configured to support multiple radio access technologies (RATs). In such embodiments, some components can be duplicated (e.g., separate device readable medium 1180 for the different RATs) and some components can be reused (e.g., the same antenna 1162 can be shared by the RATs). Network node 1160 can also include multiple sets of the various illustrated components for different wireless technologies integrated into network node 1160, such as, for example, GSM, WCDMA, LTE, NR, WiFi, or Bluetooth wireless technologies. These wireless technologies can be integrated into the same or different chip or set of chips and other components within network node 1160.

Processing circuitry 1170 can be configured to perform any determining, calculating, or similar operations (e.g., certain obtaining operations) described herein as being provided by a network node. These operations performed by processing circuitry 1170 can include processing information obtained by processing circuitry 1170 by, for example, converting the obtained information into other information, comparing the obtained information or converted information to to information stored in the network node, and/or performing one or more operations based on the obtained information or converted information, and as a result of said processing making a determination.

Processing circuitry 1170 can comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. Such functionality can include providing any of the various wireless features, functions, or benefits discussed herein.

For example, processing circuitry 1170 can execute instructions stored in device readable medium 1180 or in memory within processing circuitry 1170. In some embodiments, processing circuitry 1170 can include a system on a chip (SOC). As a more specific example, instructions (also referred to as a computer program product) stored in medium 1180 can include instructions that, when executed by processing circuitry 1170, can configure network node 1160 to perform operations corresponding to various exemplary methods (e.g., procedures) described herein.

In some embodiments, processing circuitry 1170 can include one or more of radio frequency (RF) transceiver circuitry 1172 and baseband processing circuitry 1174. In some embodiments, radio frequency (RF) transceiver circuitry 1172 and baseband processing circuitry 1174 can be on separate chips (or sets of chips), boards, or units, such as radio units and digital units. In alternative embodiments, part or all of RF transceiver circuitry 1172 and baseband processing circuitry 1174 can be on the same chip or set of chips, boards, or units

In certain embodiments, some or all of the functionality described herein as being provided by a network node, base station, eNB or other such network device can be performed by processing circuitry 1170 executing instructions stored on device readable medium 1180 or memory within processing circuitry 1170. In alternative embodiments, some or all of the functionality can be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160 but are enjoyed by network node 1160 as a whole, and/or by end users and the wireless network generally.

Device readable medium 1180 can comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that can be used by processing circuitry 1170. Device readable medium 1180 can store any suitable instructions, data or information, including a computer program, software, an application including one or more of logic, rules, code, tables, etc. and/or other instructions capable of being executed by processing circuitry 1170 and, utilized by network node 1160. Device readable medium 1180 can be used to store any calculations made by processing circuitry 1170 and/or any data received via interface 1190. In some embodiments, processing circuitry 1170 and device readable medium 1180 can be considered to be integrated.

Interface 1190 is used in the wired or wireless communication of signalling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that can be coupled to, or in certain embodiments a part of, antenna 1162. Radio front end circuitry 1192 comprises filters 1198 and amplifiers 1196. Radio front end circuitry 1192 can be connected to antenna 1162 and processing circuitry 1170. Radio front end circuitry can be configured to condition signals communicated between antenna 1162 and processing circuitry 1170. Radio front end circuitry 1192 can receive digital data that is to be sent out to other network nodes or WDs via a wireless connection. Radio front end circuitry 1192 can convert the digital data into a radio signal having the appropriate channel and bandwidth parameters using a combination of filters 1198 and/or amplifiers 1196. The radio signal can then be transmitted via antenna 1162. Similarly, when receiving data, antenna 1162 can collect radio signals which are then converted into digital data by radio front end circuitry 1192. The digital data can be passed to processing circuitry 1170. In other embodiments, the interface can comprise different components and/or different combinations of components.

In certain alternative embodiments, network node 1160 may not include separate radio front end circuitry 1192, instead, processing circuitry 1170 can comprise radio front end circuitry and can be connected to antenna 1162 without separate radio front end circuitry 1192. Similarly, in some embodiments, all or some of RF transceiver circuitry 1172 can be considered a part of interface 1190. In still other embodiments, interface 1190 can include one or more ports or terminals 1194, radio front end circuitry 1192, and RF transceiver circuitry 1172, as part of a radio unit (not shown), and interface 1190 can communicate with baseband processing circuitry 1174, to which is part of a digital unit (not shown).

Antenna 1162 can include one or more antennas, or antenna arrays, configured to send and/or receive wireless signals. Antenna 1162 can be coupled to radio front end circuitry 1190 and can be any type of antenna capable of transmitting and receiving data and/or signals wirelessly. In some embodiments, antenna 1162 can comprise one or more omni-directional, sector or panel antennas operable to transmit/receive radio signals between, for example, 2 GHz and 66 GHz. An omni-directional antenna can be used to transmit/receive radio signals in any direction, a sector antenna can be used to transmit/receive radio signals from devices within a particular area, and a panel antenna can be a line of sight antenna used to transmit/receive radio signals in a relatively straight line. In some instances, the use of more than one antenna can be referred to as MIMO. In certain embodiments, antenna 1162 can be separate from network node 1160 and can be connectable to network node 1160 through an interface or port.

Antenna 1162, interface 1190, and/or processing circuitry 1170 can be configured to perform any receiving operations and/or certain obtaining operations described herein as being performed by a network node. Any information, data and/or signals can be received from a wireless device, another network node and/or any other network equipment. Similarly, antenna 1162, interface 1190, and/or processing circuitry 1170 can be configured to perform any transmitting operations described herein as being performed by a network node. Any information, data and/or signals can be transmitted to a wireless device, another network node and/or any other network equipment.

Power circuitry 1187 can comprise, or be coupled to, power management circuitry and can be configured to supply the components of network node 1160 with power for performing the functionality described herein. Power circuitry 1187 can receive power from power source 1186. Power source 1186 and/or power circuitry 1187 can be configured to provide power to the various components of network node 1160 in a form suitable for the respective components (e.g., at a voltage and current level needed for each respective component). Power source 1186 can either be included in, or external to, power circuitry 1187 and/or network node 1160. For example, network node 1160 can be connectable to an external power source (e.g., an electricity outlet) via an input circuitry or interface such as an electrical cable, whereby the external power source supplies power to power circuitry 1187. As a further example, power source 1186 can comprise a source of power in the form of a battery or battery pack which is connected to, or integrated in, power circuitry 1187. The battery can provide backup power should the external power source fail. Other types of power sources, such as photovoltaic devices, can also be used.

Alternative embodiments of network node 1160 can include additional components beyond those shown in FIG. 11 that can be responsible for providing certain aspects of the network node's functionality, including any of the functionality described herein and/or any functionality necessary to support the subject matter described herein. For example, network node 1160 can include user interface equipment to allow and/or facilitate input of information into network node 1160 and to allow and/or facilitate output of information from network node 1160. This can allow and/or facilitate a user to perform diagnostic, maintenance, repair, and other administrative functions for network node 1160.

In some embodiments, a WD (e.g., WD 1110) can be configured to transmit and/or receive information without direct human interaction. For instance, a WD can be designed to transmit information to a network on a predetermined schedule, when triggered by an internal or external event, or in response to requests from the network. Examples of a WD include, but are not limited to, smart phones, mobile phones, cell phones, voice over IP (VoIP) phones, wireless local loop (WLL) phones, desktop computers, personal digital assistants (PDAs), wireless cameras, gaming consoles or devices, music storage devices, playback appliances, wearable terminal devices (e.g., smart watches), wireless endpoints, mobile stations, tablets, laptops, laptop-embedded equipment (LEE), laptop-mounted equipment (LME), smart devices, wireless customer-premise equipment (CPE), vehicle-mounted wireless terminal devices, etc.

A WD can support device-to-device (D2D) communication, for example by implementing a 3GPP standard for sidelink communication, vehicle-to-vehicle (V2V), vehicle-to-infrastructure (V2I), vehicle-to-everything (V2X) and can in this case be referred to as a D2D communication device. As yet another specific example, in an Internet of Things (IoT) scenario, a WD can represent a machine or other device that performs monitoring and/or measurements, and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Particular examples of such machines or devices are sensors, metering devices such as power meters, industrial machinery, home or personal appliances (e.g., refrigerators, televisions, etc.), and personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, such that it can also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 can include multiple sets of one or more of the illustrated components for different wireless technologies supported by WD 1110, such as, for example, GSM, WCDMA, LTE, NR, WiFi, WiMAX, or Bluetooth wireless technologies, just to mention a few. These wireless technologies can be integrated into the same or different chips or set of chips as other components within WD 1110.

Antenna 1111 can include one or more antennas or antenna arrays, configured to send and/or receive wireless signals, and is connected to interface 1114. In certain alternative embodiments, antenna 1111 can be separate from WD 1110 and be connectable to WD 1110 through an interface or port. Antenna 1111, interface 1114, and/or processing circuitry 1120 can be configured to perform any receiving or transmitting operations described herein as being performed by a WD. Any information, data and/or signals can be received from a network node and/or another WD. In some embodiments, radio front end circuitry and/or antenna 1111 can be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and can be configured to condition signals communicated between antenna 1111 and processing circuitry 1120. Radio front end circuitry 1112 can be coupled to or a part of antenna 1111. In some embodiments, WD 1110 may not include separate radio front end circuitry 1112; rather, processing circuitry 1120 can comprise radio front end circuitry and can be connected to antenna 1111. Similarly, in some embodiments, some or all of RF transceiver circuitry 1122 can be considered a part of interface 1114. Radio front end circuitry 1112 can receive digital data that is to be sent out to other network nodes or WDs via a wireless connection. Radio front end circuitry 1112 can convert the digital data into a radio signal having the appropriate channel and bandwidth parameters using a combination of filters 1118 and/or amplifiers 1116. The radio signal can then be transmitted via antenna 1111. Similarly, when receiving data, antenna 1111 can collect radio signals which are then converted into digital data by radio front end circuitry 1112. The digital data can be passed to processing circuitry 1120. In other embodiments, the interface can comprise different components and/or different combinations of components.

Processing circuitry 1120 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality can include providing any of the various wireless features or benefits discussed herein.

For example, processing circuitry 1120 can execute instructions stored in device readable medium 1130 or in memory within processing circuitry 1120 to provide the functionality disclosed herein. As a more specific example, instructions (also referred to as a computer program product) stored in medium 1130 can include instructions that, when executed by processing circuitry 1120, can configure wireless device 1110 to perform operations corresponding to various exemplary methods (e.g., procedures) described herein.

As illustrated, processing circuitry 1120 includes one or more of RF transceiver circuitry 1122, baseband processing circuitry 1124, and application processing circuitry 1126. In other embodiments, the processing circuitry can comprise different components and/or different combinations of components. In certain embodiments processing circuitry 1120 of WD 1110 can comprise a SOC. In some embodiments, RF transceiver circuitry 1122, baseband processing circuitry 1124, and application processing circuitry 1126 can be on separate chips or sets of chips. In alternative embodiments, part or all of baseband processing circuitry 1124 and application processing circuitry 1126 can be combined into one chip or set of chips, and RF transceiver circuitry 1122 can be on a separate chip or set of chips. In still alternative embodiments, part or all of RF transceiver circuitry 1122 and baseband processing circuitry 1124 can be on the same chip or set of chips, and application processing circuitry 1126 can be on a separate chip or set of chips. In yet other alternative embodiments, part or all of RF transceiver circuitry 1122, baseband processing circuitry 1124, and application processing circuitry 1126 can be combined in the same chip or set of chips. In some embodiments, RF transceiver circuitry 1122 can be a part of interface 1114. RF transceiver circuitry 1122 can condition RF signals for processing circuitry 1120.

In certain embodiments, some or all of the functionality described herein as being performed by a WD can be provided by processing circuitry 1120 executing instructions stored on device readable medium 1130, which in certain embodiments can be a computer-readable storage medium. In alternative embodiments, some or all of the functionality can be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 can be configured to perform any determining, calculating, or similar operations (e.g., certain obtaining operations) described herein as being performed by a WD. These operations, as performed by processing circuitry 1120, can include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 can be operable to store a computer program, software, an application including one or more of logic, rules, code, tables, etc. and/or other instructions capable of being executed by processing circuitry 1120. Device readable medium 1130 can include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that can be used by processing circuitry 1120. In some embodiments, processing circuitry 1120 and device readable medium 1130 can be considered to be integrated.

User interface equipment 1132 can include components that allow and/or facilitate a human user to interact with WD 1110. Such interaction can be of many forms, such as visual, audial, tactile, etc. User interface equipment 1132 can be operable to produce output to the user and to allow and/or facilitate the user to provide input to WD 1110. The type of interaction can vary depending on the type of user interface equipment 1132 installed in WD 1110. For example, if WD 1110 is a smart phone, the interaction can be via a touch screen; if WD 1110 is a smart meter, the interaction can be through a screen that provides usage (e.g., the number of gallons used) or a speaker that provides an audible alert (e.g., if smoke is detected). User interface equipment 1132 can include input interfaces, devices and circuits, and output interfaces, devices and circuits. User interface equipment 1132 can be configured to allow and/or facilitate input of information into WD 1110, and is connected to processing circuitry 1120 to allow and/or facilitate processing circuitry 1120 to process the input information. User interface equipment 1132 can include, for example, a microphone, a proximity or other sensor, keys/buttons, a touch display, one or more cameras, a USB port, or other input circuitry. User interface equipment 1132 is also configured to allow and/or facilitate output of information from WD 1110, and to allow and/or facilitate processing circuitry 1120 to output information from WD 1110. User interface equipment 1132 can include, for example, a speaker, a display, vibrating circuitry, a USB port, a headphone interface, or other output circuitry. Using one or more input and output interfaces, devices, and circuits, of user interface equipment 1132, WD 1110 can communicate with end users and/or the wireless network, and allow and/or facilitate them to benefit from the functionality described herein.

Auxiliary equipment 1134 is operable to provide more specific functionality which may not be generally performed by WDs. This can comprise specialized sensors for doing measurements for various purposes, interfaces for additional types of communication such as wired communications etc. The inclusion and type of components of auxiliary equipment 1134 can vary depending on the embodiment and/or scenario.

Power source 1136 can, in some embodiments, be in the form of a battery or battery pack. Other types of power sources, such as an external power source (e.g., an electricity outlet), photovoltaic devices or power cells, can also be used. WD 1110 can further comprise power circuitry 1137 for delivering power from power source 1136 to the various parts of WD 1110 which need power from power source 1136 to carry out any functionality described or indicated herein. Power circuitry 1137 can in certain embodiments comprise power management circuitry. Power circuitry 1137 can additionally or alternatively be operable to receive power from an external power source; in which case WD 1110 can be connectable to the external power source (such as an electricity outlet) via input circuitry or an interface such as an electrical power cable. Power circuitry 1137 can also in certain embodiments be operable to deliver power from an external power source to power source 1136. This can be, for example, for the charging of power source 1136. Power circuitry 1137 can perform any converting or other modification to the power from power source 1136 to make it suitable for supply to the respective components of WD 1110.

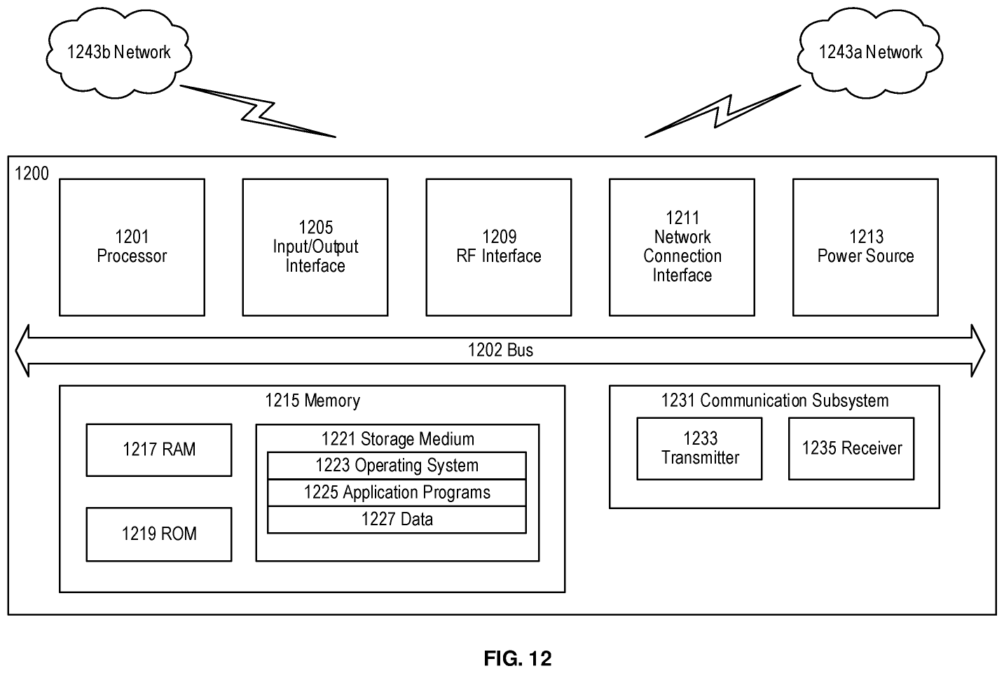

FIG. 12 illustrates one embodiment of a UE in accordance with various aspects described herein. As used herein, a user equipment or UE may not necessarily have a user in the sense of a human user who owns and/or operates the relevant device. Instead, a UE can represent a device that is intended for sale to, or operation by, a human user but which may not, or which may not initially, be associated with a specific human user (e.g., a smart sprinkler controller). Alternatively, a UE can represent a device that is not intended for sale to, or operation by, an end user but which can be associated with or operated for the benefit of a user (e.g., a smart power meter). UE 12210 can be any UE identified by the 3^{rd} Generation Partnership Project (3GPP), including a NB-IoT UE, a machine type communication (MTC) UE, and/or an enhanced MTC (eMTC) UE. UE 1200, as illustrated in FIG. 12, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE can be used interchangeable. Accordingly, although FIG. 12 is a UE, the components discussed herein are equally applicable to a WD, and vice-versa.

In FIG. 12, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 can include other similar types of information. Certain UEs can utilize all of the components shown in FIG. 12, or only a subset of the components. The level of integration between the components can vary from one UE to another UE. Further, certain UEs can contain multiple instances of a component, such as multiple processors, memories, transceivers, transmitters, receivers, etc.

In FIG. 12, processing circuitry 1201 can be configured to process computer instructions and data. Processing circuitry 1201 can be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 can include two central processing units (CPUs). Data can be information in a form suitable for use by a computer.

In the depicted embodiment, input/output interface 1205 can be configured to provide a communication interface to an input device, output device, or input and output device. UE 1200 can be configured to use an output device via input/output interface 1205. An output device can use the same type of interface port as an input device. For example, a USB port can be used to provide input to and output from UE 1200. The output device can be a speaker, a sound card, a video card, a display, a monitor, a printer, an actuator, an emitter, a smartcard, another output device, or any combination thereof. UE 1200 can be configured to use an input device via input/output interface 1205 to allow and/or facilitate a user to capture information into UE 1200. The input device can include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display can include a capacitive or resistive touch sensor to sense input from a user. A sensor can be, for instance, an accelerometer, a gyroscope, a tilt sensor, a force sensor, a magnetometer, an optical sensor, a proximity sensor, another like sensor, or any combination thereof. For example, the input device can be an accelerometer, a magnetometer, a digital camera, a microphone, and an optical sensor.

In FIG. 12, RF interface 1209 can be configured to provide a communication interface to RF components such as a transmitter, a receiver, and an antenna. Network connection interface 1211 can be configured to provide a communication interface to network 1243a. Network 1243a can encompass wired and/or wireless networks such as a local-area network (LAN), a wide-area network (WAN), a computer network, a wireless network, a telecommunications network, another like network or any combination thereof. For example, network 1243a can comprise a Wi-Fi network. Network connection interface 1211 can be configured to include a receiver and a transmitter interface used to communicate with one or more other devices over a communication network according to one or more communication protocols, such as Ethernet, TCP/IP, SONET, ATM, or the like. Network connection interface 1211 can implement receiver and transmitter functionality appropriate to the communication network links (e.g., optical, electrical, and the like). The transmitter and receiver functions can share circuit components, software or firmware, or alternatively can be implemented separately.

RAM 1217 can be configured to interface via bus 1202 to processing circuitry 1201 to provide storage or caching of data or computer instructions during the execution of software programs such as the operating system, application programs, and device drivers. ROM 1219 can be configured to provide computer instructions or data to processing circuitry 1201. For example, ROM 1219 can be configured to store invariant low-level system code or data for basic system functions such as basic input and output (I/O), startup, or reception of keystrokes from a keyboard that are stored in a non-volatile memory. Storage medium 1221 can be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

In one example, storage medium 1221 can be configured to include operating system 1223; application program 1225 such as a web browser application, a widget or gadget engine or another application; and data file 1227. Storage medium 1221 can store, for use by UE 1200, any of a variety of various operating systems or combinations of operating systems. For example, application program 1225 can include executable program instructions (also referred to as a computer program product) that, when executed by processor 1201, can configure UE 1200 to perform operations corresponding to various exemplary methods (e.g., procedures) described herein.

Storage medium 1221 can be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 can allow and/or facilitate UE 1200 to access computer-executable instructions, application programs or the like, stored on transitory or non-transitory memory media, to off-load data, or to upload data. An article of manufacture, such as one utilizing a communication system can be tangibly embodied in storage medium 1221, which can comprise a device readable medium.

In FIG. 12, processing circuitry 1201 can be configured to communicate with network 1243b using communication subsystem 1231. Network 1243a and network 1243b can be the same network or networks or different network or networks. Communication subsystem 1231 can be configured to include one or more transceivers used to communicate with network 1243b. For example, communication subsystem 1231 can be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver can include transmitter 1233 and/or receiver 1235 to implement transmitter or receiver functionality, respectively, appropriate to the RAN links (e.g., frequency allocations and the like). Further, transmitter 1233 and receiver 1235 of each transceiver can share circuit components, software or firmware, or alternatively can be implemented separately.

In the illustrated embodiment, the communication functions of communication subsystem 1231 can include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 can include cellular communication, Wi-Fi communication, Bluetooth communication, and GPS communication. Network 1243b can encompass wired and/or wireless networks such as a local-area network (LAN), a wide-area network (WAN), a computer network, a wireless network, a telecommunications network, another like network or any combination thereof. For example, network 1243b can be a cellular network, a Wi-Fi network, and/or a near-field network. Power source 1213 can be configured to provide alternating current (AC) or direct current (DC) power to components of UE 1200.

The features, benefits and/or functions described herein can be implemented in one of the components of UE 1200 or partitioned across multiple components of UE 1200. Further, the features, benefits, and/or functions described herein can be implemented in any combination of hardware, software or firmware. In one example, communication subsystem 1231 can be configured to include any of the components described herein. Further, processing circuitry 1201 can be configured to communicate with any of such components over bus 1202. In another example, any of such components can be represented by program instructions stored in memory that when executed by processing circuitry 1201 perform the corresponding functions described herein. In another example, the functionality of any of such components can be partitioned between processing circuitry 1201 and communication subsystem 1231. In another example, the non-computationally intensive functions of any of such components can be implemented in software or firmware and the computationally intensive functions can be implemented in hardware.

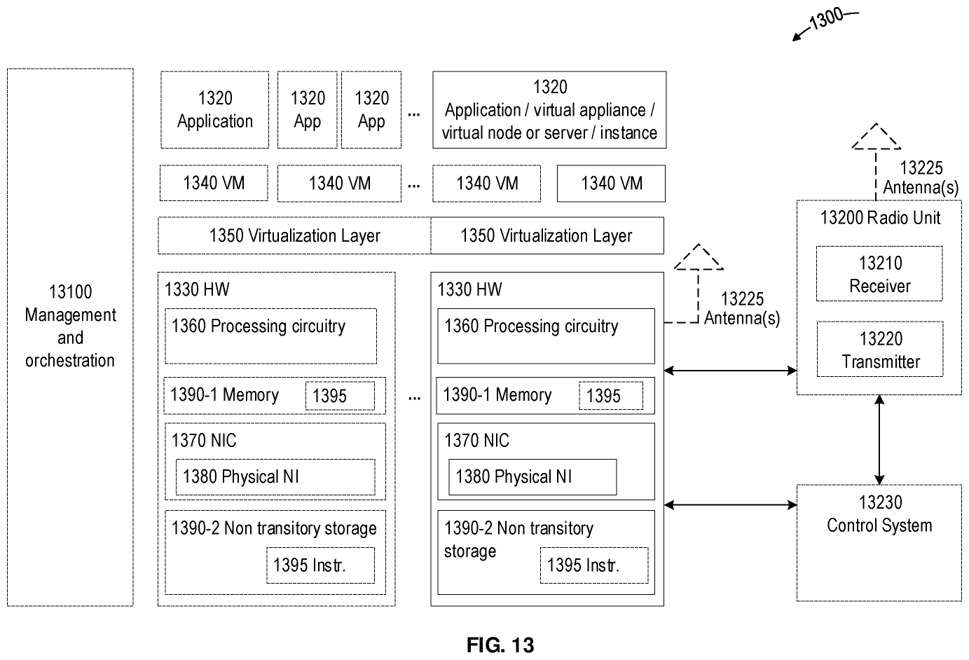

FIG. 13 is a schematic block diagram illustrating a virtualization environment 1300 in which functions implemented by some embodiments can be virtualized. In the present context, virtualizing means creating virtual versions of apparatuses or devices which can include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein can be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node can be entirely virtualized.

The functions can be implemented by one or more applications 1320 (which can alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300 comprises general-purpose or special-purpose network hardware devices 1330 comprising a set of one or more processors or processing circuitry 1360, which can be commercial off-the-shelf (COTS) processors, dedicated Application Specific Integrated Circuits (ASICs), or any other type of processing circuitry including digital or analog hardware components or special purpose processors. Each hardware device can comprise memory 1390-1 which can be non-persistent memory for temporarily storing instructions 1395 or software executed by processing circuitry 1360. For example, instructions 1395 can include program instructions (also referred to as a computer program product) that, when executed by processing circuitry 1360, can configure hardware node 1320 to perform operations corresponding to various exemplary methods (e.g., procedures) described herein. Such operations can also be attributed to virtual node(s) 1320 that is/are hosted by hardware node 1330.

Each hardware device can comprise one or more network interface controllers (NICs) 1370, also known as network interface cards, which include physical network interface 1380. Each hardware device can also include non-transitory, persistent, machine-readable storage media 1390-2 having stored therein software 1395 and/or instructions executable by processing circuitry 1360. Software 1395 can include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340 comprise virtual processing, virtual memory, virtual networking or interface and virtual storage, and can be run by a corresponding virtualization layer 1350 or hypervisor. Different embodiments of the instance of virtual appliance 1320 can be implemented on one or more of virtual machines 1340, and the implementations can be made in different ways.

During operation, processing circuitry 1360 executes software 1395 to instantiate the hypervisor or virtualization layer 1350, which can sometimes be referred to as a virtual machine monitor (VMM). Virtualization layer 1350 can present a virtual operating platform that appears like networking hardware to virtual machine 1340.

As shown in FIG. 13, hardware 1330 can be a standalone network node with generic or specific components. Hardware 1330 can comprise antenna 13225 and can implement some functions via virtualization. Alternatively, hardware 1330 can be part of a larger cluster of hardware (e.g., such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV can be used to consolidate many network equipment types onto industry standard high volume server hardware, physical switches, and physical storage, which can be located in data centers, and customer premise equipment.

In the context of NFV, virtual machine 1340 can be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13130 and one or more receivers 13130 can be coupled to one or more antennas 13225. Radio units 13200 can communicate directly with hardware nodes 1330 via one or more appropriate network interfaces and can be used in combination with the virtual components to provide a virtual node with radio capabilities, such as a radio access node or a base station.

In some embodiments, some signalling can be effected with the use of control system 13230 which can alternatively be used for communication between the hardware nodes 1330 and radio units 13200.

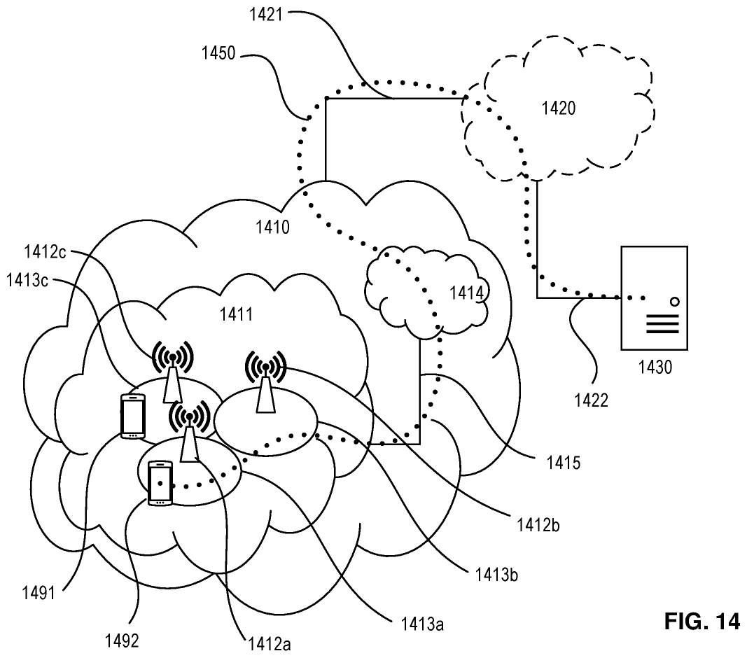

With reference to FIG. 14, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c can be configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the base station 1412a.

Telecommunication network 1410 is itself connected to host computer 1430, which can be embodied in the hardware and/or software of a standalone server, a cloud-implemented server, a distributed server or as processing resources in a server farm. Host computer 1430 can be under the ownership or control of a service provider or can be operated by the service provider or on behalf of the service provider. Connections 1421 and 1422 between telecommunication network 1410 and host computer 1430 can extend directly from core network 1414 to host computer 1430 or can go via an optional intermediate network 1420. Intermediate network 1420 can be one of, or a combination of more than one of, a public, private or hosted network; intermediate network 1420, if any, can be a backbone network or the Internet; in particular, intermediate network 1420 can comprise two or more sub-networks (not shown).

The communication system of FIG. 14 as a whole enables connectivity between the connected UEs 1491, 1492 and host computer 1430. The connectivity can be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 can be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

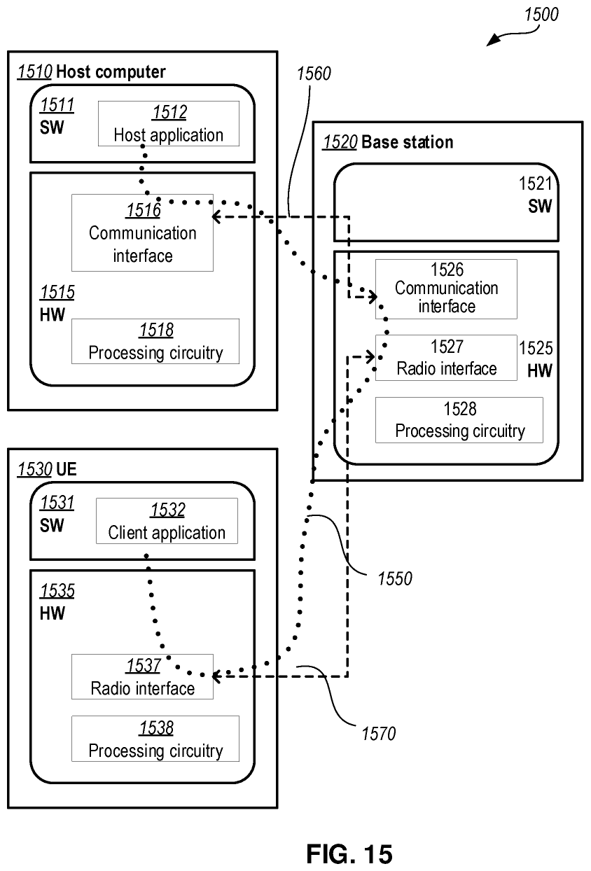

Example implementations, in accordance with an embodiment, of the UE, base station and host computer discussed in the preceding paragraphs will now be described with reference to FIG. 15. In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which can have storage and/or processing capabilities. In particular, processing circuitry 1518 can comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 can be operable to provide a service to a remote user, such as UE 1530 connecting via OTT connection 1550 terminating at UE 1530 and host computer 1510. In providing the service to the remote user, host application 1512 can provide user data which is transmitted using OTT connection 1550.

Communication system 1500 can also include base station 1520 provided in a telecommunication system and comprising hardware 1525 enabling it to communicate with host computer 1510 and with UE 1530. Hardware 1525 can include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 15) served by base station 1520. Communication interface 1526 can be configured to facilitate connection 1560 to host computer 1510. Connection 1560 can be direct, or it can pass through a core network (not shown in FIG. 15) of the telecommunication system and/or through one or more intermediate networks outside the telecommunication system. In the embodiment shown, hardware 1525 of base station 1520 can also include processing circuitry 1528, which can comprise one or more programmable processors, application-specific integrated circuits, field programmable gate arrays or combinations of these (not shown) adapted to execute instructions.

Base station 1520 also includes software 1521 stored internally or accessible via an external connection. For example, software 1521 can include program instructions (also referred to as a computer program product) that, when executed by processing circuitry 1528, can configure base station 1520 to perform operations corresponding to various exemplary methods (e.g., procedures) described herein.

Communication system 1500 can also include UE 1530 already referred to. The UE's hardware 1535 can include radio interface 1537 configured to set up and maintain wireless connection 1570 with a base station serving a coverage area in which UE 1530 is currently located. Hardware 1535 of UE 1530 can also include processing circuitry 1538, which can comprise one or more programmable processors, application-specific integrated circuits, field programmable gate arrays or combinations of these (not shown) adapted to execute instructions.

UE 1530 also includes software 1531, which is stored in or accessible by UE 1530 and executable by processing circuitry 1538. Software 1531 includes client application 1532. Client application 1532 can be operable to provide a service to a human or non-human user via UE 1530, with the support of host computer 1510. In host computer 1510, an executing host application 1512 can communicate with the executing client application 1532 via OTT connection 1550 terminating at UE 1530 and host computer 1510. In providing the service to the user, client application 1532 can receive request data from host application 1512 and provide user data in response to the request data. OTT connection 1550 can transfer both the request data and the user data. Client application 1532 can interact with the user to generate the user data that it provides. Software 1531 can also include program instructions (also referred to as a computer program product) that, when executed by processing circuitry 1538, can configure UE 1530 to perform operations corresponding to various exemplary methods (e.g., procedures) described herein.

It is noted that host computer 1510, base station 1520 and UE 1530 illustrated in FIG. 15 can be similar or identical to host computer 2150, one of base stations 2212a, 2212b, 2212c and one of UEs 2291, 2292 of FIG. 22, respectively. This is to say, the inner workings of these entities can be as shown in FIG. 15 and independently, the surrounding network topology can be that of FIG. 22.

In FIG. 15, OTT connection 1550 has been drawn abstractly to illustrate the communication between host computer 1510 and UE 1530 via base station 1520, without explicit reference to any intermediary devices and the precise routing of messages via these devices. Network infrastructure can determine the routing, which it can be configured to hide from UE 1530 or from the service provider operating host computer 1510, or both. While OTT connection 1550 is active, the network infrastructure can further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the exemplary embodiments disclosed herein can improve flexibility for the network to monitor end-to-end quality-of-service (QoS) of data flows, including their corresponding radio bearers, associated with data sessions between a user equipment (UE) and another entity, such as an OTT data application or service external to the 5G network. These and other advantages can facilitate more timely design, implementation, and deployment of 5G/NR solutions. Furthermore, such embodiments can facilitate flexible and timely control of data session QoS, which can lead to improvements in capacity, throughput, latency, etc. that are envisioned by 5G/NR and important for the growth of OTT services.

A measurement procedure can be provided for the purpose of monitoring data rate, latency and other network operational aspects on which the one or more embodiments improve. There can further be an optional network functionality for reconfiguring OTT connection 1550 between host computer 1510 and UE 1530, in response to variations in the measurement results. The measurement procedure and/or the network functionality for reconfiguring OTT connection 1550 can be implemented in software 1511 and hardware 1515 of host computer 1510 or in software 1531 and hardware 1535 of UE 1530, or both. In embodiments, sensors (not shown) can be deployed in or in association with communication devices through which OTT connection 1550 passes; the sensors can participate in the measurement procedure by supplying values of the monitored quantities exemplified above, or supplying values of other physical quantities from which software 1511, 1531 can compute or estimate the monitored quantities. The reconfiguring of OTT connection 1550 can include message format, retransmission settings, preferred routing etc.; the reconfiguring need not affect base station 1520, and it can be unknown or imperceptible to base station 1520. Such procedures and functionalities can be known and practiced in the art. In certain embodiments, measurements can involve proprietary UE signaling facilitating host computer 1510's measurements of throughput, propagation times, latency and the like. The measurements can be implemented in that software 1511 and 1531 causes messages to be transmitted, in particular empty or ‘dummy’ messages, using OTT connection 1550 while it monitors propagation times, errors etc.

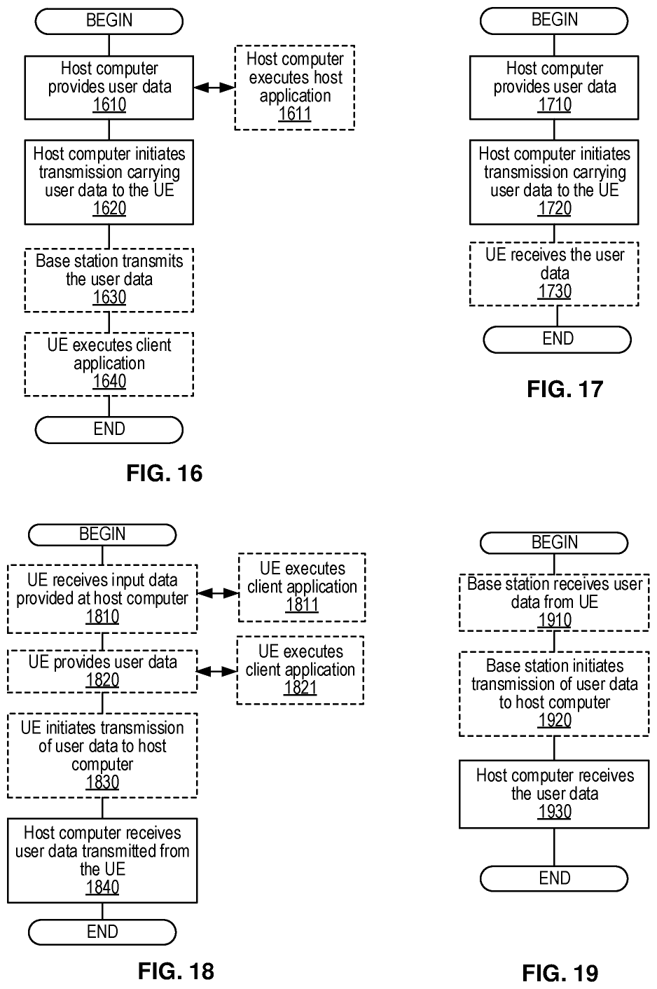

FIG. 16 is a flowchart illustrating an exemplary method and/or procedure implemented in a communication system, in accordance with one embodiment. The communication system includes a host computer, a base station and a UE which, in some exemplary embodiments, can be those described with reference to other figures. For simplicity of the present disclosure, only drawing references to FIG. 16 will be included in this section. In step 1610, the host computer provides user data. In substep 1611 (which can be optional) of step 1610, the host computer provides the user data by executing a host application. In step 1620, the host computer initiates a transmission carrying the user data to the UE. In step 1630 (which can be optional), the base station transmits to the UE the user data which was carried in the transmission that the host computer initiated, in accordance with the teachings of the embodiments described throughout this disclosure. In step 1640 (which can also be optional), the UE executes a client application associated with the host application executed by the host computer.

FIG. 17 is a flowchart illustrating an exemplary method and/or procedure implemented in a communication system, in accordance with one embodiment. The communication system includes a host computer, a base station and a UE which can be those described with reference to other figures. For simplicity of the present disclosure, only drawing references to FIG. 17 will be included in this section. In step 1710 of the method, the host computer provides user data. In an optional substep (not shown) the host computer provides the user data by executing a host application. In step 1720, the host computer initiates a transmission carrying the user data to the UE. The transmission can pass via the base station, in accordance with the teachings of the embodiments described throughout this disclosure. In step 1730 (which can be optional), the UE receives the user data carried in the transmission.

FIG. 18 is a flowchart illustrating an exemplary method and/or procedure implemented in a communication system, in accordance with one embodiment. The communication system includes a host computer, a base station and a UE which can be those described with reference to other figures. For simplicity of the present disclosure, only drawing references to FIG. 18 will be included in this section. In step 1810 (which can be optional), the UE receives input data provided by the host computer. Additionally or alternatively, in step 1820, the UE provides user data. In substep 1821 (which can be optional) of step 1820, the UE provides the user data by executing a client application. In substep 1811 (which can be optional) of step 1810, the UE executes a client application which provides the user data in reaction to the received input data provided by the host computer. In providing the user data, the executed client application can further consider user input received from the user. Regardless of the specific manner in which the user data was provided, the UE initiates, in substep 1830 (which can be optional), transmission of the user data to the host computer. In step 1840 of the method, the host computer receives the user data transmitted from the UE, in accordance with the teachings of the embodiments described throughout this disclosure.

FIG. 19 is a flowchart illustrating an exemplary method and/or procedure implemented in a communication system, in accordance with one embodiment. The communication system includes a host computer, a base station, and a UE which can be those described with reference to other figures. For simplicity of the present disclosure, only drawing references to FIG. 19 will be included in this section. In step 1910 (which can be optional), in accordance with the teachings of the embodiments described throughout this disclosure, the base station receives user data from the UE. In step 1920 (which can be optional), the base station initiates transmission of the received user data to the host computer. In step 1930 (which can be optional), the host computer receives the user data carried in the transmission initiated by the base station.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein to have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In addition, certain terms used in the present disclosure, including the specification, drawings and exemplary embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

As used herein unless expressly stated to the contrary, the phrases “at least one of” and “one or more of,” followed by a conjunctive list of enumerated items (e.g., “A and B”, “A, B, and C”), are intended to mean “at least one item, with each item selected from the list consisting of” the enumerated items. For example, “at least one of A and B” is intended to mean any of the following: A; B; A and B. Likewise, “one or more of A, B, and C” is intended to mean any of the following: A; B; C; A and B; B and C; A and C; A, B, and C.

As used herein unless expressly stated to the contrary, the phrase “a plurality of” followed by a conjunctive list of enumerated items (e.g., “A and B”, “A, B, and C”) is intended to mean “multiple items, with each item selected from the list consisting of” the enumerated items. For example, “a plurality of A and B” is intended to mean any of the following: more than one A; more than one B; or at least one A and at least one B.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

Example embodiments of the techniques and apparatus described herein include, but are not limited to, the following enumerated examples:
E1. A method, performed by a second radio access network (RAN) node serving a plurality of cells, for load balancing with a first RAN node, the method comprising:
   sending, to the first RAN node, one or more first indications related to resource aggregation capabilities for the plurality of cells; and
   in response to the first indications, receiving, from the first RAN node, one or more requests for handover of respective one or more UEs to the plurality of cells.
E2. The method of embodiment E1, further comprising sending, to the first RAN node, one or more second indications related to traffic load or available capacity for individual cells of the plurality.
E3. The method of any of embodiments E1-E2, wherein one of the following conditions applies:
   the first indications are sent in a single message; or
   a first portion of the first indications are sent during setup of an interface between the first and second RAN nodes, and a second portion of the first indications are sent after the interface is setup.
E4. The method of any of claims E1-E3, wherein:
   the first and second RAN nodes are gNBs in an NG-RAN; and
   the first indications are sent in a Resource Status Update message over an X2 interface between the first and second RAN nodes.
E5. The method of any of embodiments E1-E4, wherein the first indications include one or more of the following indications:
   that resources from the plurality of cells can be aggregated to serve a UE that is handed over to the second RAN node;
   an estimated likelihood that resources from the plurality of cells can be aggregated to serve a UE that is handed over to the second RAN node;
   that the plurality of cells overlap in coverage;
   a degree of overlap in coverage between the plurality of cells; and
   whether the plurality of cells are served by the same distributed unit (DU) or different DUs associated with the second RAN node.
E6. The method of any of embodiments E1-E5, wherein the resource aggregation capabilities include one or more of carrier aggregation (CA) and dual connectivity (DC).
E7. A method, performed by a first radio access network (RAN) node, for load balancing with a second RAN node serving a plurality of cells, the method comprising:
   receiving, from the second RAN node, one or more first indications related to resource aggregation capabilities for the plurality of cells served by the second RAN node; and
   based on the first indications, determining one or more of the following:
      overall capacity available for offloading UEs to the plurality of cells;
      whether resources from the plurality of cells can be aggregated to meet service requirements of one or more UEs served by the first RAN node; and
      one more UEs to be handed over the second RAN node.
E8. The method of embodiment E7, further comprising, in response to the determining operation, sending, to the second RAN node, one or more requests for handover of respective one or more UEs to the plurality of cells.
E9. The method of any of embodiments E7-E8, wherein:
   the method further comprises receiving, from the second RAN node, one or more second indications related to traffic load or available capacity for individual cells of the plurality; and
   the determining operation is further based on the second indications.
E10. The method any of embodiments E7-E9, wherein:
   the method further comprises receiving, from one or more UEs served by the first RAN node, measurements relating to the plurality of cells served by the second RAN node; and
   the determining operation is further based on the measurements.
E11. The method of any of embodiments E7-E10, wherein one of the following conditions applies:
   the first indications are received in a single message; or
   a first portion of the first indications are received during setup of an interface between the first and second RAN nodes, and a second portion of the first indications are received after the interface is setup.
E12. The method of any of embodiments E7-E11, wherein:
   the first and second RAN nodes are gNBs in an NG-RAN; and
   the first indications are received in a Resource Status Update message over an X2 interface between the first and second RAN nodes.
E13. The method of any of embodiments E7-E12, wherein the first indications include one or more of the following indications:
   that resources from the plurality of cells can be aggregated to serve a UE that is handed over to the second RAN node;
   an estimated likelihood that resources from the plurality of cells can be aggregated to serve a UE that is handed over to the second RAN node;
   that the plurality of cells overlap in coverage;
   a degree of overlap in coverage between the plurality of cells; and
   whether the plurality of cells are served by the same distributed unit (DU) or different DUs associated with the second RAN node.
E14. The method of any of embodiments E7-E13, wherein the resource aggregation capabilities include one or more of carrier aggregation (CA) and dual connectivity (DC).
E15. A second radio access network (RAN) node configured for load balancing with a first RAN node, the second RAN node comprising:
   communication interface circuitry configured to communicate with one or more user equipment (UEs) and with the first RAN node; and
   processing circuitry operably coupled with the communication interface circuitry, whereby the processing circuitry and the communication interface circuitry are configured to perform operations corresponding to any of the methods of embodiments E1-E6.
E16. A second radio access network (RAN) node configured for load balancing with a first RAN node, the second RAN node being further arranged to perform operations corresponding to any of the methods of embodiments E1-E6.
E17. A non-transitory, computer-readable medium storing program instructions that, when executed by processing circuitry of a second radio access network (RAN) node, configure the second RAN node to perform operations corresponding to any of the methods of embodiments E1-E6.
E18. A computer program product comprising program instructions that, when executed by processing circuitry of a second radio access network (RAN) node, configure the second RAN node to perform operations corresponding to any of the methods of embodiments E1-E6.
E19. A first radio access network (RAN) node configured for load balancing with a second RAN node, the first RAN node comprising:
   communication interface circuitry configured to communicate with one or more user equipment (UEs) and with the second RAN node; and
   processing circuitry operably coupled with the communication interface circuitry, whereby the processing circuitry and the communication interface circuitry are configured to perform operations corresponding to any of the methods of embodiments E7-E14.
E20. A first radio access network (RAN) node configured for load balancing with a second RAN node, the first RAN node being further arranged to perform operations corresponding to any of the methods of embodiments E7-E14.
E21. A non-transitory, computer-readable medium storing program instructions that, when executed by processing circuitry of a first radio access network (RAN) node, configure the first RAN node to perform operations corresponding to any of the methods of embodiments E7-E14.
E22. A computer program product comprising program instructions that, when executed by processing circuitry of a first radio access network (RAN) node, configure the first RAN node to perform operations corresponding to any of the methods of embodiments E7-E14.

1.-28. (canceled)

29. A method performed by a first radio access network (RAN) node for load balancing with a second RAN node, the method comprising:
receiving, from the second RAN node, one or more first indications related to resource aggregation capabilities for a plurality of cells served by the second RAN node; and
determining one or more of the following based on the first indications:
overall capacity available for offloading user equipment (UEs) to the plurality of cells;
whether resources from the plurality of cells can be aggregated to meet service requirements of one or more UEs served by the first RAN node; and
one or more UEs to be handed over to the second RAN node.

30. The method of claim 29, further comprising, in response to the determining operation, sending to the second RAN node one or more requests for handover of respective one or more UEs to the plurality of cells.

31. The method of claim 29, wherein:
the method further comprises receiving from the second RAN node one or more second indications related to traffic load or available capacity for individual cells of the plurality; and
the determining operation is further based on the second indications.

32. The method claim 29, wherein:
the method further comprises receiving, from one or more UEs served by the first RAN node, measurements relating to the plurality of cells served by the second RAN node; and
the determining operation is further based on the measurements.

33. The method of claim 29, wherein one of the following applies:
the first indications are received in a single message; or
a first portion of the first indications are received during setup of an interface between the first and second RAN nodes, and a second portion of the first indications are received after the interface is setup.

34. The method of claim 29, wherein:
the first and second RAN nodes are gNB s in an NG-RAN; and
the first indications are received in a Resource Status Update message over an Xn interface between the first and second RAN nodes.

35. The method of claim 29, wherein the first indications include one or more of the following:
an indication that resources from the plurality of cells can be aggregated to serve a UE that is handed over to the second RAN node;
an estimated likelihood that resources from the plurality of cells can be aggregated to serve a UE that is handed over to the second RAN node;
an indication that the plurality of cells overlap in coverage;
a degree of overlap in coverage between the plurality of cells; and
an indication of whether the plurality of cells are served by one or multiple distributed units (DUs) associated with the second RAN node.

36. The method of claim 29, wherein the resource aggregation capabilities indicated by the first indication include one or more of the following: carrier aggregation (CA) and dual connectivity (DC).

37. The method of claim 29, wherein determining the one or more UEs to be handed over to the second RAN node comprises selecting the one or more UEs to be handed over based on UE support for the resource aggregation capabilities indicated by the first indications.

38. A method performed by a second radio access network (RAN) node for load balancing with a first RAN node, the method comprising:
sending, to the first RAN node, one or more first indications related to resource aggregation capabilities for a plurality of cells served by the second RAN node; and
receiving, from the first RAN node, one or more requests for handover of respective one or more user equipment (UEs) to the plurality of cells associated with the one or more first indications.

39. The method of claim 38, further comprising sending, to the first RAN node, one or more second indications related to traffic load or available capacity for individual cells of the plurality.

40. The method of claim 38, wherein one of the following conditions applies:
the first indications are sent in a single message; or
a first portion of the first indications are sent during setup of an interface between the first and second RAN nodes, and a second portion of the first indications are sent after the interface is setup.

41. The method of claim 38, wherein:
the first and second RAN nodes are gNB s in an NG-RAN; and
the first indications are sent in a Resource Status Update message over an Xn interface between the first and second RAN nodes.

42. The method of claim 38, wherein the first indications include one or more of the following:
an indication that resources from the plurality of cells can be aggregated to serve a UE that is handed over to the second RAN node;
an estimated likelihood that resources from the plurality of cells can be aggregated to serve a UE that is handed over to the second RAN node;
an indication that the plurality of cells overlap in coverage;
a degree of overlap in coverage between the plurality of cells; and
an indication of whether the plurality of cells are served by one or multiple distributed units (DUs) associated with the second RAN node.

43. The method of claim 38, wherein the resource aggregation capabilities indicated by the first indication include one or more of the following: carrier aggregation (CA) and dual connectivity (DC).

44. The method of claim 38, further comprising, after handover of the one or more UEs, communicating with at least one of the UEs using aggregated resources from the plurality of cells associated with the one or more first indications.

45. A first radio access network (RAN) node configured for load balancing with a second RAN node, the first RAN node comprising:
communication interface circuitry configured to communicate with one or more user equipment (UEs) and with the second RAN node; and
processing circuitry operably coupled with the communication interface circuitry, whereby the processing circuitry and the communication interface circuitry are configured to:
receive, from the second RAN node, one or more first indications related to resource aggregation capabilities for a plurality of cells served by the second RAN node; and
determine one or more of the following based on the first indications:
overall capacity available for offloading user UEs to the plurality of cells;
whether resources from the plurality of cells can be aggregated to meet service requirements of one or more UEs served by the first RAN node; and
one or more UEs to be handed over to the second RAN node.

46. A non-transitory, computer-readable medium storing program instructions that, when executed by processing circuitry of a first radio access network (RAN) node configured for load balancing with a second RAN node, configure the first RAN node to perform operations corresponding to the method of claim 29.

47. A second radio access network (RAN) node configured for load balancing with a first RAN node, the second RAN node comprising:
communication interface circuitry configured to communicate with one or more user equipment (UEs) and with the first RAN node; and
processing circuitry operably coupled with the communication interface circuitry, whereby the processing circuitry and the communication interface circuitry are configured to perform operations corresponding to the method of claim 38.

48. A non-transitory, computer-readable medium storing program instructions that, when executed by processing circuitry of a second radio access network (RAN) node configured for load balancing with a first RAN node, configure the second RAN node to perform operations corresponding to the method of claim 38.
